(19) United States
(12) Patent Application Publication
(10) Pub. No.: US 2006/0179994 A1
(43) Pub. Date: Aug. 17, 2006

(54) Punching mold

(75) Inventor: Shozo Onmori, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/344,177

(22) Filed: Feb. 1, 2006

(30) Foreign Application Priority Data
Feb. 17, 2005 (JP) 2005-040906
Feb. 17, 2005 (JP) 2005-040907
Feb. 17, 2005 (JP) 2005-040908
Feb. 17, 2005 (JP) 2005-040909
Feb. 23, 2005 (JP) 2005-047675
Feb. 23, 2005 (JP) 2005-047676

(51) Int. Cl. B26F 1/14

(52) U.S. Cl. 83/685

(57) ABSTRACT

A punching mold having a die in which a through-hole is formed, and a punch which fits together with the through-hole and which punches a workpiece which is placed on the die. With one punching mold, the punching mold punches elongated products corresponding to a plurality of overall lengths which are different. End surfaces of the product are formed with high precision over an entire longitudinal direction region. Progressive feeding of a source material sheet for punching and forming the product is carried out smoothly.

### CROSS-REFERENCE TO RELATED APPLICATIONS

This application claims priority under 35 USC 119 from Japanese Patent Applications Nos. 2005-40906, 2005-40907, 2005-40908, 2005-40909, 2005-47675, and 2005-47676, the disclosures of which are incorporated by reference herein.

### BACKGROUND OF THE INVENTION

1. Field of the Invention

The present invention relates to a punching mold which punches a source material by a press.

2. Description of the Related Art

There are conventionally known recording tape cartridges in which a recording tape, such as a magnetic tape or the like which is used as a data recording/playback medium of a computer or the like, is wound around a single reel, and the reel is accommodated within a case. A leader member, such as a leader pin, a leader tape, or a leader block, is provided at the distal end of the recording tape. The leader member is pulled-out from an opening of the recording tape cartridge by a pull-out means provided at a drive device, and the recording tape which is fastened to the leader member is taken-up onto a take-up reel of the drive device (refer to Japanese Patent Application Laid-Open (JP-A) No. 2004-342203).

The leader tape which is used as the leader member is formed by punching a source material sheet, which is formed of PET or the like and is usually a thickness of about 100 to 200 μm, by a punching mold (a press mold) formed from a punch and a die. Precision which is higher than that of a usual metal pressed product is required for the precision of the end surfaces of the leader tape (the precision/straightness of the cut surfaces), in the same order as that of the magnetic tape which is joined to the leader tape. Namely, very high precision is required of the punching mold which forms the leader tape.

On the other hand, the overall length of the leader tape is determined in consideration of the drive device, and therefore, differs in accordance with the drive device which is used. Thus, there is the need to prepare punching molds which form leader tapes corresponding to the lengths of the leader tapes. Namely, a punching mold must be newly manufactured each time the overall length of the leader tape changes. Newly fabricating a punching mold in correspondence with the overall length of the leader tape in this way is related to an increase in the cost of forming the leader tape.

Further, when punching a long, rectilinear leader tape out from a source material, distortion arises due to the shearing force of the punch which the source material receives, and shear droop due to the biting-in of the punch arises. Burred or crushed edges thereby remain at the end surfaces of the punched-out leader tape.

If burred edges remain at the end surfaces of the leader tape, when the leader tape is taken-up onto a take-up reel, the edges are shaved-off and stick to the recording tape, and become a cause of so-called drop-out of the recording or playback signal.

The source material sheet is placed on the surface of the die, and is progressively fed at a uniform pitch in a predetermined direction. On the other hand, a through-hole, with which the punch fits together, is formed in the die. At the time of forming the through-hole, there are cases in which burr-like projections are formed at the corner portions of the through-hole. At this time, feeding of the source material sheet is impeded by these projections. Further, there are cases in which the source material sheet contacts the projections and scratches are formed in the source material sheet, and the scratches remain in the product which is formed by punching the source material sheet.

The leader tape which is used as the leader member is formed by punching a source material sheet, which is formed from PET and is usually a thickness of 100 to 200 μm, by a press mold. The press mold is structured by one die and one punch, and the punch fits-together with a through-hole formed in the die.

As mentioned above, precision which is higher than that of a usual metal pressed product is required for the precision of the end surfaces of the leader tape (the precision/straightness of the cut surfaces), in the same order as that of the magnetic tape which is joined to the leader tape. Namely, very high accuracy is required of the press mold which forms the leader tape. Therefore, the through-hole provided at the die also must be formed with very high precision. In particular, in cases in which an elongated product such as the leader tape is formed, the cost of the mold becomes high. Further, in cases in which the through-hole becomes worn due to the punch fitting-together therewith, the die must be newly fabricated, and this also becomes a cause of an increase in costs.

Further, as mentioned above, the leader tape which is used as the leader member is formed by punching a source material sheet, which is formed of PET and is usually a thickness of 100 to 200 μm, by a press mold, and precision which is higher than that of a usual metal pressed product is required for the precision of the end surfaces of the leader tape (the precision/straightness of the cut surfaces), in the same order as that at the magnetic tape which is joined to the leader tape. Accordingly, very high precision is required of the press mold which forms the leader tape.

Usually, a clearance of about 10 μm at one side is provided between the die (the hole formed in the die) and the punch of the press mold which punches the leader tape. By maintaining this clearance of 10 μm, the precision of the end surfaces of the leader tape punched-out from the source material of PET can be made to be high.

However, in a case in which the overall length of the leader tape is long, e.g., in the case of punching a leader tape whose overall length is about 500 mm, even if a clearance of 10 μm can be provided locally between the punch and the die, it is extremely difficult to maintain a clearance of 10 μm over the entire length. Therefore, there are the concerns that the precision of the end surfaces of the leader tape may deteriorate, and that burrs may arise at the end surfaces.

### SUMMARY OF THE INVENTION

Accordingly, by making it possible to punch products corresponding to a plurality of different overall lengths by one punching mold, the present invention contemplates reducing the manufacturing costs of the products, forming end surfaces of the products with high precision, enabling progressive feeding of a source material sheet to be carried out smoothly, forming end surfaces of a leader tape with high precision by a low-cost punching mold, and forming end surfaces of elongated products with high precision over the entire longitudinal direction regions thereof.

A first aspect of the present invention is a punching mold having a die in which a through-hole is formed, and a punch which fits-together with the through-hole and which punches a workpiece which is placed on the die, wherein a step surface is formed at a punching surface of the punch which punching surface contacts the workpiece, and a block, which abuts the step surface and impedes punching of a step surface portion, is fitted together with the through-hole.

A second aspect of the present invention is a punching mold having a die in which a through-hole is formed, and a punch which fits together with the through-hole and which punches a workpiece which is placed on the die, wherein, when the punch punches the workpiece, punching times at which the workpiece is punched are made to be different at one longitudinal direction end portion of the punch from at another longitudinal direction end portion of the punch.

A third aspect of the present invention is a punching mold having a die in which a through-hole is formed, and a punch which fits together with the through-hole and which punches a workpiece which is placed on the die, wherein, at the punch, a corner portion of a punching surface which contacts and punches the workpiece, is formed at an acute angle.

A fourth aspect of the present invention is a punching mold comprising: a die in which a through-hole is formed at a placement surface on which a workpiece is placed; and a punch which fits together with the through-hole, and which punches the workpiece which is placed on the placement surface, wherein a corner portion of the through-hole, which is substantially orthogonal to a direction of feeding the workpiece, is chamfered.

A fifth aspect of the present invention is a punching mold comprising: a die in which a through-hole is formed at a placement surface on which a workpiece is placed; and a punch which fits together with the through-hole, and which punches the workpiece which is placed on the placement surface, wherein a step surface, which is parallel to the placement surface, is provided at a corner portion at a peripheral edge of the through-hole, and a corner portion, which is formed by the placement surface and an upright surface of the step surface, is chamfered.

A sixth aspect of the present invention is a leader tape punching mold which forms a leader tape, the punching mold having a die in which a through-hole is formed, and a punch which fits together with the through-hole and which punches a workpiece which is placed on the die, and the punching mold being structured so as to form a leader tape having an elongated portion, which is attached to an end portion of a recording tape and which is provided in an elongated form along a longitudinal direction of the recording tape, and jutting portions, which are provided at a distal end of the elongated portion and jut-out in a transverse direction of the recording tape, wherein the die is structured by combining a first mold which forms the elongated portion, and a second mold which forms the jutting portions of the leader tape.

A seventh aspect of the present invention is a punching mold comprising: a die structured by a block in which a through-hole is formed, and a pressing member which is provided at an outer side of the block and which presses the block; and a punch which fits together with the through-hole and punches a workpiece which is placed on the die.

Other aspects, features, and advantages of the present invention will become apparent from the following description taken in conjunction with the accompanying drawings.

### BRIEF DESCRIPTION OF THE DRAWINGS

Preferred embodiments of the present invention will be described in detail based on the following figures, in which:

FIG. 1 is a schematic perspective view of a punching mold in accordance with the present invention;

FIG. 2 is a schematic side view of a punching mold in accordance with a first embodiment of the present invention;

FIG. 3A is a schematic perspective view of a punching mold of a leader tape of an overall length L, and shows a state before punching;

FIG. 3B is a schematic perspective view of the punching mold of the leader tape of the overall length L, and shows a punched state;

FIG. 4 is a schematic exploded perspective view of a punching mold of a leader tape of an overall length M;

FIG. 5 is a schematic perspective view of the punching mold of the leader tape of the overall length M;

FIG. 6A is a schematic sectional view of the punching mold of the leader tape of the overall length M, and shows a state before punching;

FIG. 6B is a schematic sectional view of the punching mold of the leader tape of the overall length M, and shows a punched state;

FIG. 7A is a schematic sectional view of the punching mold of the leader tape of the overall length L, and shows a state before punching;

FIG. 7B is a schematic sectional view of the punching mold of the leader tape of the overall length L, and shows a punched state;

FIG. 8 is a schematic side view of a punching mold in accordance with a second embodiment of the present invention;

FIG. 9A is a schematic perspective view of the punching mold, and shows a state before punching;

FIG. 9B is a schematic perspective view of the punching mold, and shows a punched state;

FIG. 10 is a perspective view showing a die and a punch of the punching mold, and shows a state as seen from a reverse side;

FIGS. 11A, 11B, and 11C are schematic sectional views of a punching mold of a leader tape;

FIGS. 12A, 12B, and 12C are schematic sectional views of a punching mold in accordance with another form of the present embodiment;

FIG. 13 is a schematic side view of a punching mold in accordance with a third embodiment of the present invention;

FIG. 14 is a perspective view showing a die and a punch of the punching mold, and shows a state as seen from a reverse side;

FIGS. 15A and 15B are schematic sectional views of the punching mold;

FIG. 16 is a schematic sectional view of a punching mold in accordance with another form of the present embodiment;

FIG. 17 is a schematic side view of a punching mold in accordance with a fourth embodiment of the present invention;

FIG. 18A is a schematic perspective view of the punching mold, and shows a state before punching;

FIG. 18B is a schematic perspective view of the punching mold, and shows a punched state;

FIG. 19 is a partial perspective view showing a die of the punching mold;

FIGS. 20A and 20B are schematic sectional views of the punching mold;

FIGS. 21A, 21B, and 21C are schematic sectional views of a punching mold of a leader tape in accordance with another form of the present embodiment;

FIGS. 22A, 22B, and 22C are schematic sectional views of a punching mold in accordance with yet another form of the present embodiment;

FIG. 23 is a schematic perspective view of a punching mold in accordance with a fifth embodiment of the present invention;

FIG. 24 is a schematic side view of the punching mold;

FIG. 25A is a schematic perspective view of the punching mold, and shows a state before punching of a workpiece;

FIG. 25B is a schematic perspective view of the mold, and shows a punched state of the workpiece;

FIG. 26 is an exploded perspective view showing the structure of a die of the punching mold;

FIG. 27 is a front view showing the structure of the die of the punching mold;

FIG. 28 is a schematic perspective view of the punching mold;

FIG. 29 is a schematic side view of a punching mold in accordance with a sixth embodiment of the present invention;

FIG. 30A is a schematic perspective view of the punching mold, and shows a state before punching of a workpiece;

FIG. 30B is a schematic perspective view of the mold, and shows a punched state of the workpiece;

FIG. 31 is an exploded perspective view showing the structure of a die of the punching mold;

FIG. 32 is a front view showing the structure of the die of the punching mold;

FIGS. 33A and 33B are front views showing a state in which a punch is fit-together with a through-hole of the die of the punching mold; and

FIG. 34 is a schematic perspective view of a magnetic tape cartridge at which a leader tape, which is formed by the punching mold, is provided.

### DETAILED DESCRIPTION OF THE INVENTION

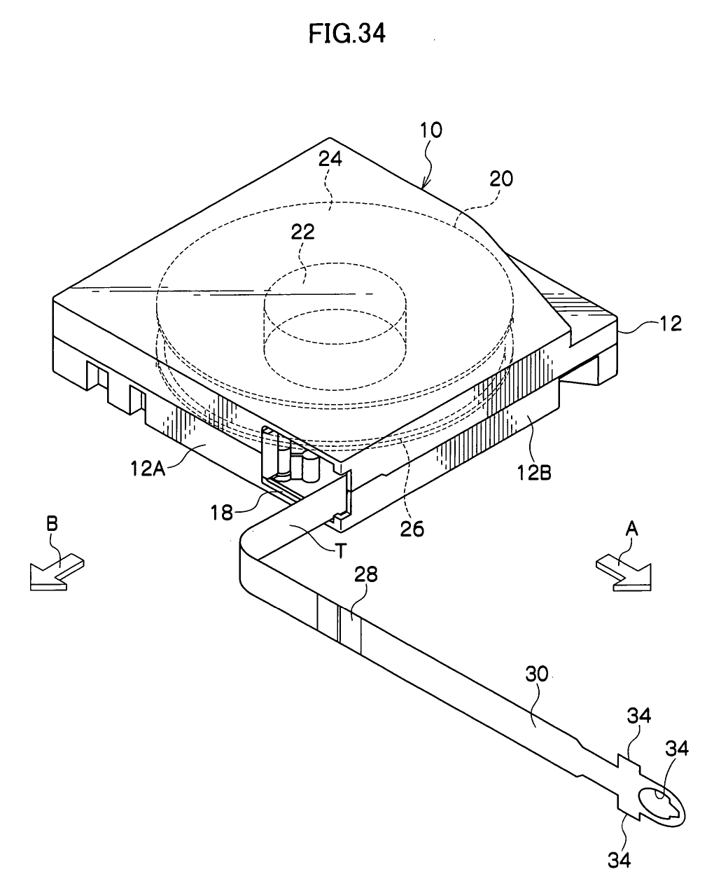

First, a recording tape cartridge 10, at which is provided a leader tape 30 which is formed by a punching mold of the structure of the present invention, will be briefly described by using FIG. 34. Note that, for convenience of explanation, the recording tape is magnetic tape T, and the recording tape cartridge 10 is the magnetic tape cartridge 10. Further, in FIG. 34, the direction of loading the magnetic tape cartridge 10 into a drive device is indicated by arrow A, and this is the front direction (front side) of the magnetic tape cartridge 10. The direction of arrow B, which is orthogonal to arrow A, is the right direction (right side).

The magnetic tape cartridge 10 has a substantially rectangular box-shaped case 12. A reel 20 is rotatably accommodated within the case 12. The reel 20 is structured by a reel hub 22, which is shaped as a cylindrical tube having a floor and which structures the axially central portion of the reel 20, and an upper flange 24, which is provided at the top end portion of the reel hub 22, being formed integrally, and a lower flange 26 being ultrasonically welded to the bottom end portion of the leader hub 22. The magnetic tape T, which serves as an information recording/playback medium, is wound around the outer peripheral surface of the reel hub 22. The transverse direction end portions of the wound magnetic tape T are held by the upper flange 24 and the lower flange 26.

An opening 18, which is for the pulling-out of the magnetic tape T which is wound on the reel 20, is formed in a wall 12A of the case 12. A leader tape 30 which is made of plastic is attached by a splice tape 28, which serves as a tape for connection, to the free end portion of the magnetic tape T which is pulled-out from the opening 18.

The leader tape 30 is a member to be pulled-out, which is engaged by a pull-out member (not shown) of a drive device in order to pull-out the magnetic tape T. The leader tape 30 has an elongated portion 31 having the same width as the magnetic tape T. A hole 32, with which the pull-out member engages, is formed in a vicinity of the leading end of the elongated portion 31. Jutting portions 34, which jut-out upwardly and downwardly respectively, are formed at the top and bottom both sides of the leader tape 30, slightly more rearward than the rear end of the hole portion 32. Within the case 12, the leader tape 30 is disposed (held) along a wall 12B due to the jutting portions 34 being accommodated (inserted) in accommodating recesses (not shown) which are formed respectively in the inner surface of an upper case 14 and the inner surface of a lower case 16 in a vicinity of the opening 18. Further, concave portions 33 are formed in the elongated portion 31 in vicinities of the jutting portions 34.

### First Embodiment

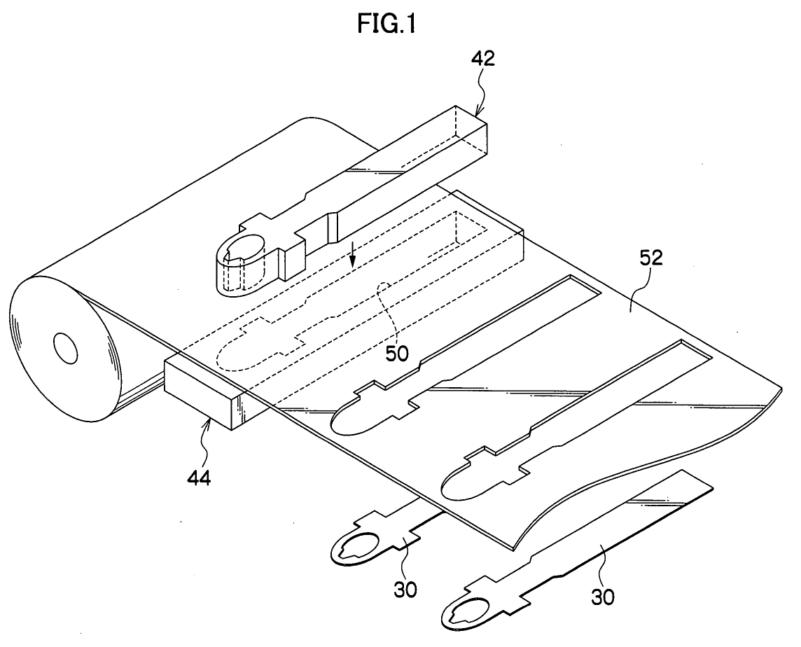

A punching mold 40 relating to the present embodiment will be described. Here, as shown in FIG. 1, explanation will be given by using as an example the punching mold 40 which forms the leader tape 30 which is provided at, for example, the magnetic tape cartridge shown in FIG. 34.

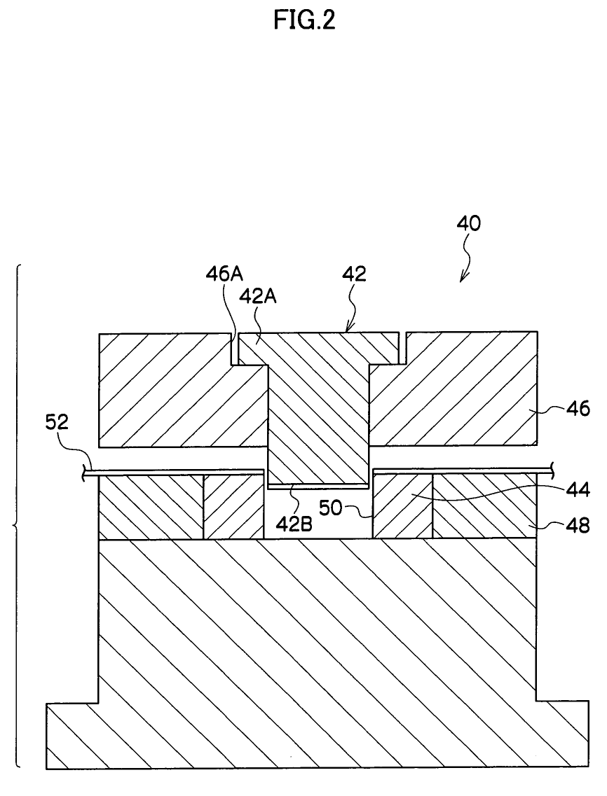

As shown in FIG. 2, the punching mold 40 has a punch holder 46 which holds a punch 42, and a die holder 48 which holds a die 44. The punch holder 46 and the die holder 48 are positioned by guide posts (not shown). The punch holder 46 is movable in the perpendicular direction with respect to the die holder 48.

A flange portion 42A is provided at the punch 42. The flange portion 42A is fixed by unillustrated bolts to a step portion 46A of the punch holder 46. In this way, as the punch holder 46 moves, the punch 42 moves in vertical directions with respect to the die 44.

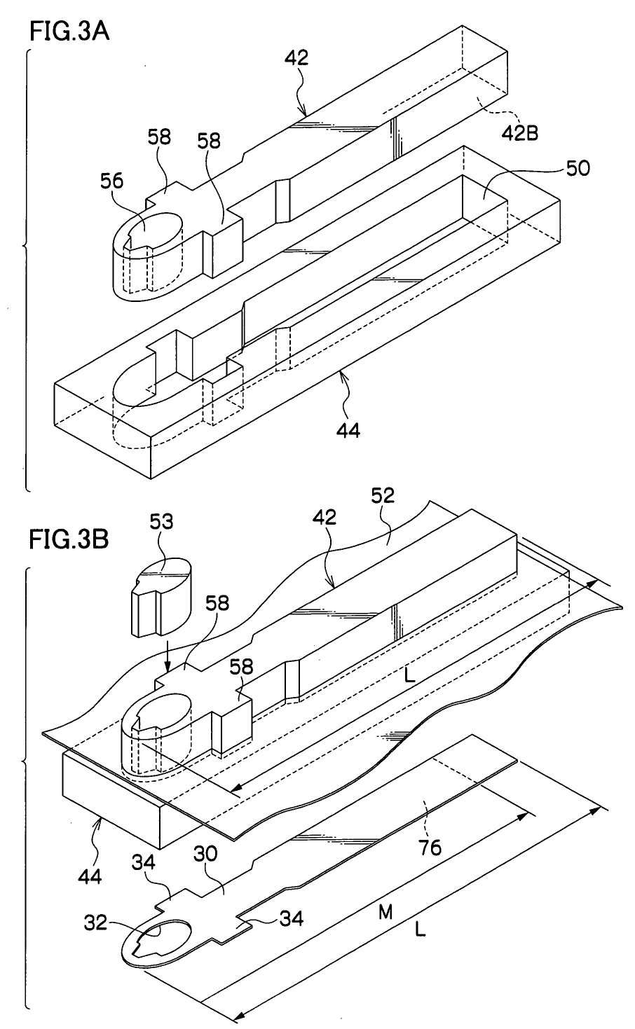

As shown in FIGS. 2 and 3A, a through-hole 50, with which the punch 42 can fit together, is formed in the die 44. In this way, when the punch 42 is lowered, the punch 42 fits together with the through-hole 50 of the die 44. Note that the flange portion 42A of the punch 42 is illustrated only in FIG. 2.

As shown in FIG. 3B, a workpiece 52 (sheet-like PET) is placed on the surface of the die 44 which surface faces the punch 42. Then, when the punch 42 is lowered and fits in the through-hole formed in the die 44, shearing force acts along the outer configuration of a punching surface 42B of the punch 42, and the workpiece 52 is punched.

The punching surface 42B of the punch 42 is the same configuration as that of the leader tape 30 which will be described later. Namely, projecting portions 58, which have configurations corresponding to the jutting portions 34 of the leader tape 30 (see FIG. 34), are formed at one longitudinal direction end portion of the punching surface 42B. A hole portion 56, with which a punch 53 for forming the hole 32 of the leader tape 30 can fit together, is provided in the one end portion of the punch 42. Due to the workpiece 52 being punched by the die 44 and the punch 42 having this configuration, the leader tape 30 of the illustrated configuration is formed.

Here, explanation will be given of a case in which the overall length of the leader tape 30 is changed due to a design change or the like.

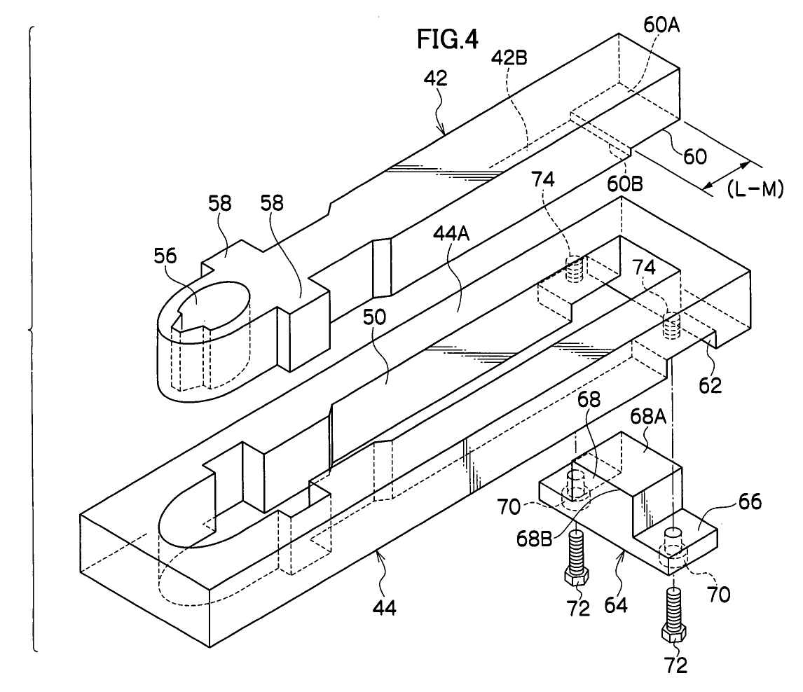

For example, as shown in FIG. 3B, when forming the leader tape 30 of an overall length L, the punch 42 whose longitudinal direction dimension is L is used. When forming a leader tape 76, which is shown by the dotted line in the drawings and whose overall length is M (where L>M), by using the punch 42, as shown in FIG. 4, a step surface 60 whose longitudinal direction size is (L-M) is formed at the other end portion of the punching surface 42B of the punch 42 (the end portion at the side opposite the side where the projecting portions 58 are formed).

On the other hand, the through-hole 50 which is formed in the die 44 has the same configuration as the outer shape of the punch 42. The one end portion of the through-hole 50 has a shape corresponding to the projecting portions 58 of the punch 42. Moreover, a substantially rectangular concave portion 62 is formed in the reverse surface of the die 44, in a vicinity of the other end portion with the through-hole 50 therebetween.

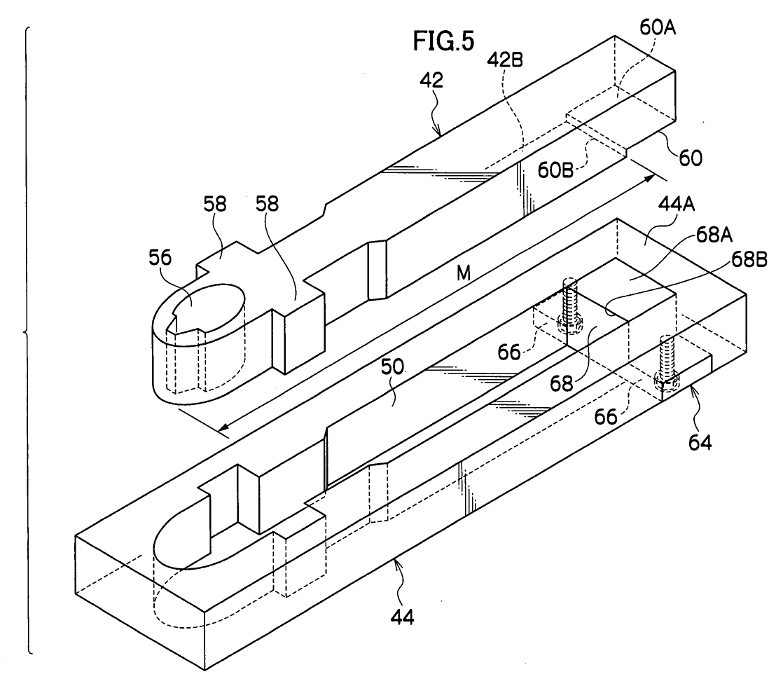

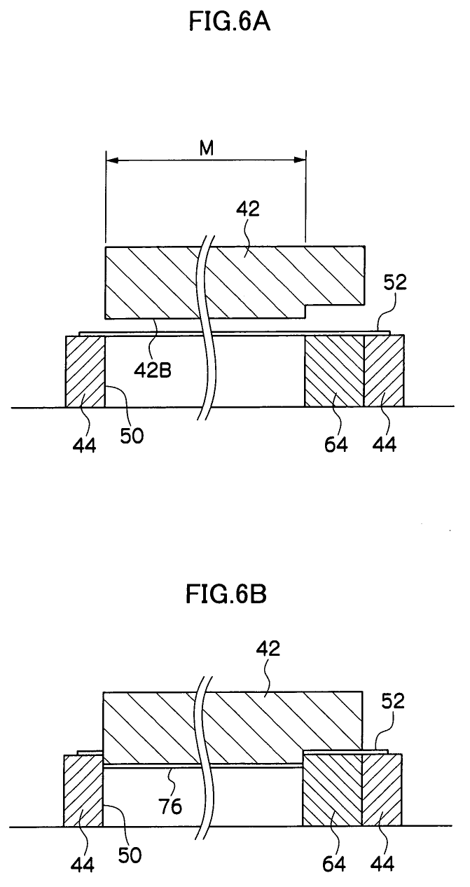

A flange member 66 of a block 64 fits-together with the concave portion 62. The block 64 is structured by the flange member 66, and a convex portion 68 which extends from the substantially central portion of the flange member 66, and is formed in substantially a T shape when viewed from one direction. Screw holes 70 are formed in the flange member 66. Due to screws 72, which are inserted through the screw holes 70, being screwed together with taps 74 formed in the concave portion 62, the block 64 is mounted from the reverse side of the die 44 as shown in FIG. 5.

When the block 64 is mounted from the reverse surface of the die 44, the convex portion 68 of the block 64 is fitted together with the through-hole 50 of the die 44. A top surface 68A of the convex portion 68 which is fitted together with the through-hole 50 is formed to be substantially the same height as the front surface 44A of the die 44. Further, a corner portion 68B of the top surface 68A is abutted by a corner portion 60B of the step surface 60. In this way, when the punch 42 is fitted together with the through-hole 50 of the die 44, the step surface 60 of the punch 42 is supported by the top surface 68A of the convex portion 68 of the block 64, shearing force arises between the corner portion 60B and the corner portion 68B, and the leader tape 76 of the overall length M is punched-out.

In the present embodiment, the block 64, which has the convex portion 68 of a surface area which is substantially the same size as the surface area of a supporting surface 60A of the step surface 60, is fitted together with the through-hole 50. However, it is not absolutely necessary to make the top surface 68A of the convex portion 68 have substantially the same surface area as the surface area of the supporting surface 60A of the step surface 60. The size of the supporting surface 60A is not particularly limited, provided that the corner portion 60B of the step surface 60 can be made to abut the corner portion 68B of the convex portion 68.

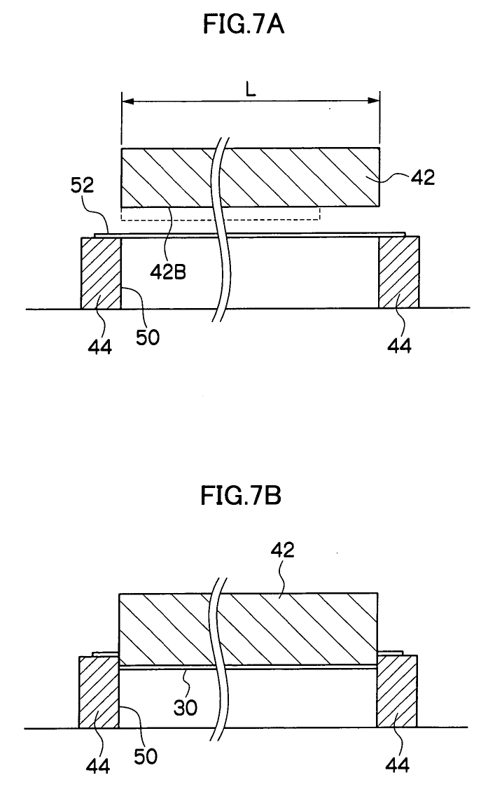

After the step surface 60 is formed at the punching surface 42B of the punch 42 and the leader tape 76 of the overall length M is formed, if the leader tape 30 of the overall length L is to be formed by using this punch 42, as shown in FIG. 7, the punching surface 42B is ground so as to be the same height as the supporting surface 60A of the step surface 60. Then, it suffices to remove the block 64 (see FIG. 5) which is fitted together with the through-hole 50 of the die 44, and fit the punch 42 together with the through-hole 50. At this time, the distance over which the punch 42 is lowered (the stroke) must be made to be larger, by an amount corresponding to the ground amount, than at the time of forming the leader tape 76 of the overall length M.

In this way, even if the demanded overall length of the leader tape changes due to a design change or the like, a leader tape of a different overall length can be formed merely by forming the step surface 60 and grinding the punching surface 42B to match the supporting surface 60A of the step surface 60.

Operation of the first embodiment of the present invention will be described next.

As shown in FIGS. 1 and 3B, the punch 42 contacts the workpiece 52 which is placed at the die 44. By fitting the punch 42 together with the through-hole 50, the leader tape 30 to be attached to the end portion of the recording tape T is formed.

At this time, the leader tape 30 is formed by being punched-out along the outer shape of the punching surface 42B of the punch 42. Thus, by forming the step surface 60 at the punching surface 42B of the punch 42, the outer shape of the punching surface 42B can be changed without changing the size of the punch 42 itself

In this way, because the size of the punch 42 itself is not changed, there is no need to change the size of the through-hole 50 either, and there is no need to prepare a new punching mold each time the overall length of the leader tape 30 changes due to a design change or the like. Accordingly, the cost of the leader tape 30 can be kept low.

Further, owing to the structure in which the step surface 60 is supported by the block 64, the punch 42 can be prevented from tilting at the time when the punch 42 is fitted together with the through-hole 50. The stability of the punch 42 can thereby be maintained.

Note that, in the present embodiment, explanation is given by using as an example the punching mold 40 which punches the leader tape 30 which is provided at the recording tape cartridge 10. However, the present invention is not particularly limited to the punching mold 40 of the leader tape 30, and, provided that it is a punching mold which punches a product from a source material sheet, the present invention can be applied.

### Second Embodiment

The punching mold 40 relating to the present embodiment will be described. Here, as shown in FIG. 1, explanation will be given by using as an example the punching mold 40 which forms the leader tape 30 which is provided at the magnetic tape cartridge 10 (see FIG. 34) for example. Note that FIG. 1 is used in common to illustrate the present embodiment as well, and therefore, will be referred to in the explanation of the present embodiment.

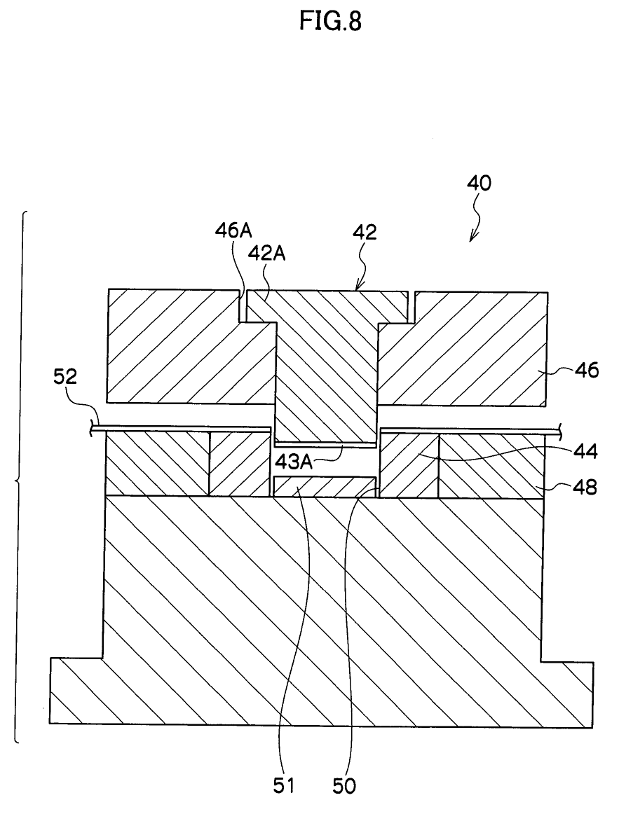

As shown in FIG. 8, the punching mold 40 has the punch holder 46 which holds the punch 42, and the die holder 48 which holds the die 44. The punch holder 46 and the die holder 48 are positioned by guide posts (not shown). The punch holder 46 is movable in the vertical direction with respect to the die holder 48. Note that a punch restraining plate 51 is provided in the through-hole 50. When the punch 42 is lowered, the punch 42 is supported by the punch restraining plate 51.

The flange portion 42A is provided at the punch 42. The flange portion 42A is fixed by unillustrated bolts to the step portion 46A of the punch holder 46. In this way, as the punch holder 46 moves, the punch 42 moves in vertical directions with respect to the die 44.

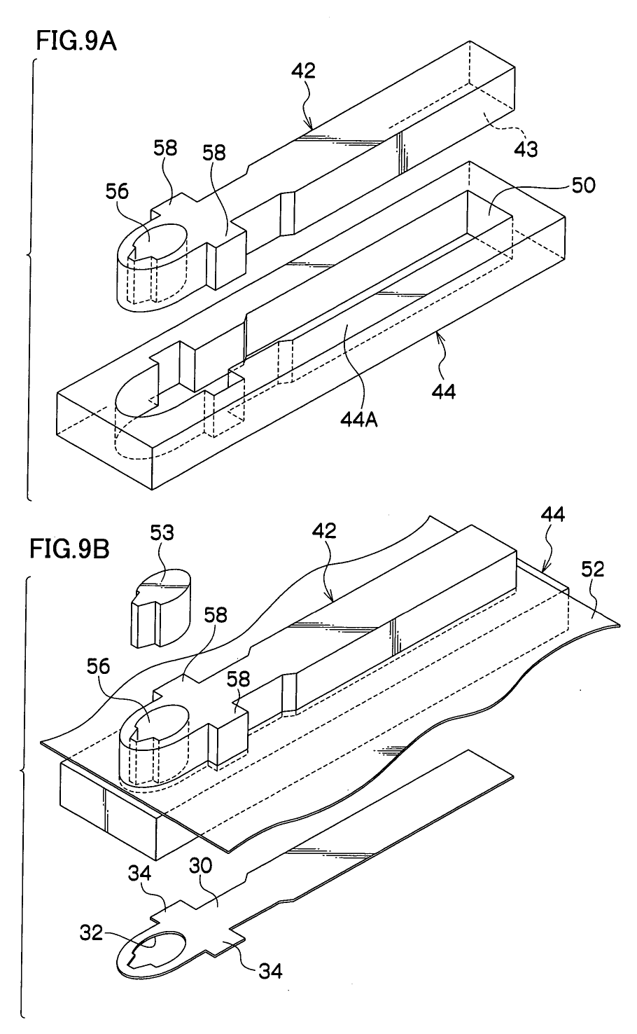

As shown in FIGS. 8 and 9A, the through-hole 50, with which the punch 42 can fit together, is formed in the die 44. In this way, when the punch 42 is lowered, the punch 42 fits together with the through-hole 50 of the die 44. Further, the punch restraining plate 51 is provided in the through-hole 50, and when the punch 42 is lowered, the punch 42 is supported by the punch restraining plate 51. Note that the flange portion 42A of the punch 42 is illustrated only in FIG. 8.

As shown in FIGS. 1 and 9B, the workpiece 52 (sheet-like PET) is placed on the surface of the die 44 which surface faces the punch 42. Then, when the punch 42 is lowered and fits-together with the through-hole 50 formed in the die 44, shearing force acts along the outer configuration of a punching surface 43 of the punch 42, and the workpiece 52 is punched.

The punching surface 43 of the punch 42 is the same configuration as that of the leader tape 30 which will be described later. Namely, the projecting portions 58, which have configurations corresponding to the jutting portions 34 of the leader tape 30, are formed at one longitudinal direction end portion of the punching surface 43. The hole portion 56, with which the punch 53 for forming the hole 32 of the leader tape 30 can fit together, is provided in the one end portion of the punch 42. Due to the workpiece 52 being punched by the die 44 and the punch 42 having this configuration, the leader tape 30 of the illustrated configuration is formed.

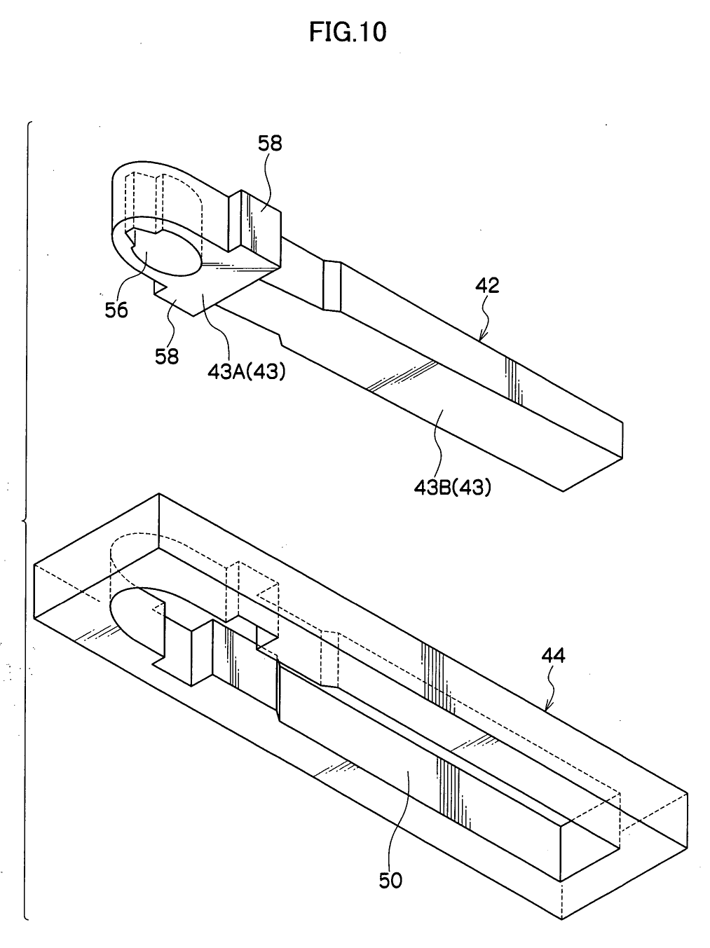

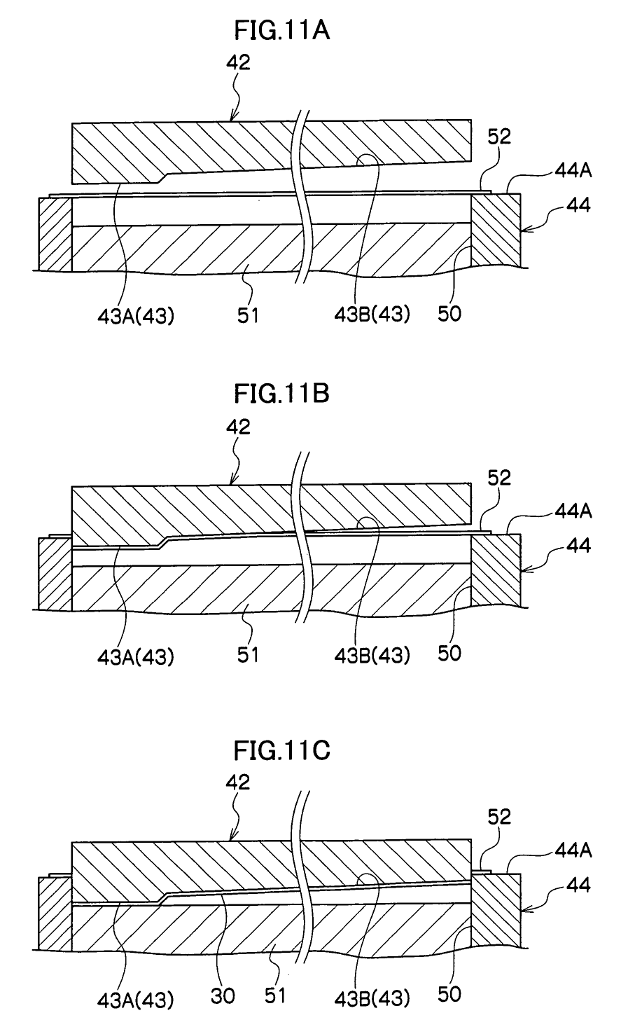

A view of the punch 42 as seen from the punching surface 43 side is shown in FIG. 10, and views of the punch 42 as seen from the side surface side are shown in FIGS. 11A through 11C.

The punching surface 43 of the punch 42 has the same configuration as the leader tape 30. Namely, the projecting portions 58, which have shapes corresponding to the jutting portions 34 of the leader tape 30, are formed at one longitudinal direction end portion of the punching surface 43. The side at which these projecting portions 58 are formed is a projection side punching surface 43A. The punching surface corresponding to the straight portion of the punched-out leader tape 30 is a straight side punching surface 43B.

Note that the hole portion 56, with which the punch 53 for forming the hole 32 of the leader tape 30 can fit together, is provided in one end portion of the punch 42. Due to the workpiece 52 being punched by the die 44 and the punch 42 having this configuration, the leader tape 30 having a configuration such as that shown in FIG. 9B is formed.

As shown in FIGS. 10 and 11A, a step surface is formed at the punching surface 43 of the punch 42, and this step surface is the straight side punching surface 43B. Namely, in FIG. 5, the projection side punching surface 43A is structured so as to be positioned further downward than the straight side punching surface 43B. Note that the depth of the step surface (the straight side punching surface 43B) is a size which is one to two times the thickness of the workpiece 52.

The projection side punching surface 43A is formed parallel to the placement surface 44A of the die 44 on which the workpiece 52 is placed. On the other hand, the straight side punching surface 43B is tapered so as to slope upwardly by 1 to 2° toward the other end portion with respect to the placement surface 44A.

In this way, when the punch 42 is lowered vertically toward the workpiece 52, as shown in FIG. 11B, first, the projection side punching surface 43A of the punch 42 contacts the workpiece 52. Then, when the punch 42 is lowered further, the straight side punching surface 43B gradually contacts the workpiece 52, from the one end portion to the other end portion of the straight side punching surface 43B.

Namely, after being punched-out all at once by the projection side punching surface 43A which is not tapered, the complex configuration of the leader tape 30 (see FIGS. 9A and 9B) is gradually punched-out from the one end portion toward the other end portion by the straight side punching surface 43B which is tapered. In this way, as shown in FIG. 11C, the workpiece 52 is punched in a shape which runs along the external configuration of the punching surface 43 of the punch 42, and the leader tape 30 is molded.

The present embodiment is structured such that, as shown in FIG. 8, at the punch 42 which is fitted together with the through-hole 50, only the projection side punching surface 43A is supported by the punch restraining plate 51 which is provided in the through-hole 50. However, by using a punch restraining plate of a configuration which supports not only the projection side punching surface 43A but also the straight side punching surface 43B as well, tilting of the punch 42 at the time when the punch 42 is fitted together with the through-hole 50 can be prevented. The stability of the punch 42 can thereby be maintained.

Operation of the embodiment of the present invention will be described next.

The punch 42 contacts the workpiece 52 which is placed at the die 44, and by fitting the punch 42 together with the through-hole 50, the leader tape 30 to be attached to the end portion of the recording tape T is formed (see FIGS. 9A and 9B).

For example, at positions corresponding to one end portion and the other end portion of the leader tape 30, in a case in which the workpiece 52 is punched all at once by the entire punching surface 43 of the punch 42 which is long and thin, the workpiece 52 receives rectilinear shearing force from the punch 42 and is distorted, and there are cases in which the punch 42 bites into the workpiece 52.

Thus, at the one longitudinal direction end portion and the other longitudinal direction end portion of the leader tape 30, the punching times for punching the workpiece 52 are made to be different. In this way, the shearing force which the workpiece 52 receives from the punching surface 43 of the punch 42 gradually moves while concentrating at one point. Therefore, there is little distortion of the workpiece 52, and shear droop caused by the biting-in of the punching surface 43 of the punch 42 does not arise. Namely, because there is no fear that the portion at the periphery of the workpiece 52 which becomes the leader tape 30 will enter into the through-hole 50 of the die 44, burr-like edges do not remain at the end surfaces of the punched-out leader tape 30. Accordingly, the end surfaces of the leader tape 30 can be formed with high precision.

Further, at the time when the projection side punching surface 43A becomes worn, the worn portion is removed by grinding the projection side punching surface 43A. At this time, by forming a step which is greater than or equal to the thickness of the workpiece 52 at the punching surface 43, the grinding margin of the projection side punching surface 43A can be sufficiently ensured. Therefore, it suffices to grind only the projection side punching surface 43A, and not grind the straight side punching surface 43B.

By providing the border between the projection side punching surface 43A and the straight side punching surface 43B of the punch 42 at a portion of the leader tape 30 which is other than the straight portion thereof, the end surfaces of the straight portion of the leader tape 30 can be prevented from showing shear droop due to the border between the projection side punching surface 43A and the straight side punching surface 43B.

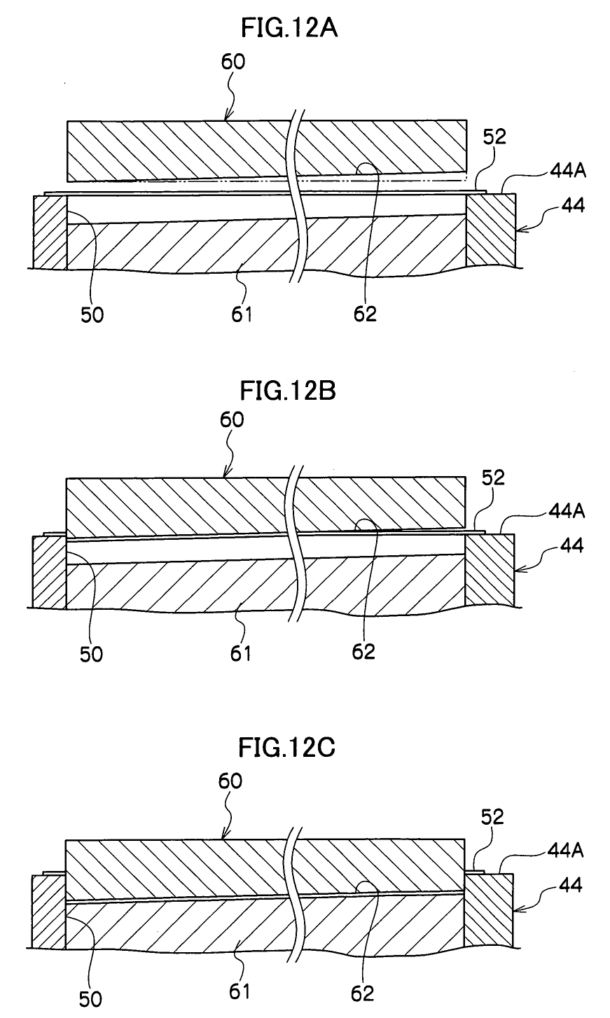

Further, in the present embodiment, as shown in FIGS. 9A and 9B, explanation is given by using as an example the punch of the punching mold 40 which punches the leader tape 30 at which the jutting portions 34 (see FIG. 34) are provided. However, in the case of punching a leader tape which is straight overall and at which no complicated shapes such as jutting portions or the like are provided, the workpiece 52 may be punched by using a punch 60 which is tapered over the entire region from one end portion of a punching surface 62 to the other end portion thereof, as shown in FIG. 12A. In this way, when the punch 60 is lowered, as shown in FIG. 12B, first, one end portion of the punching surface 62 contacts the workpiece 52. As shown in FIG. 12C, the workpiece 52 is gradually punched from the one end portion of the punching surface 62 toward the other end portion thereof.

In this case, by forming a taper also at a punch restraining plate 61 which is provided in the through-hole 50, tilting of the punch 60 at the time when the punch 60 is fitted together with the through-hole 50 can be prevented. The stability of the punch 60 can thereby be maintained.

### Third Embodiment

The punching mold 40 relating to the present embodiment will be described. Here, as shown in FIG. 1, explanation will be given by using as an example the punching mold 40 which forms the leader tape 30 which is provided at the magnetic tape cartridge 10 (see FIG. 34) for example. Note that FIG. 1 is used in common to illustrate the present embodiment as well, and therefore, will be referred to in the explanation of the present embodiment.

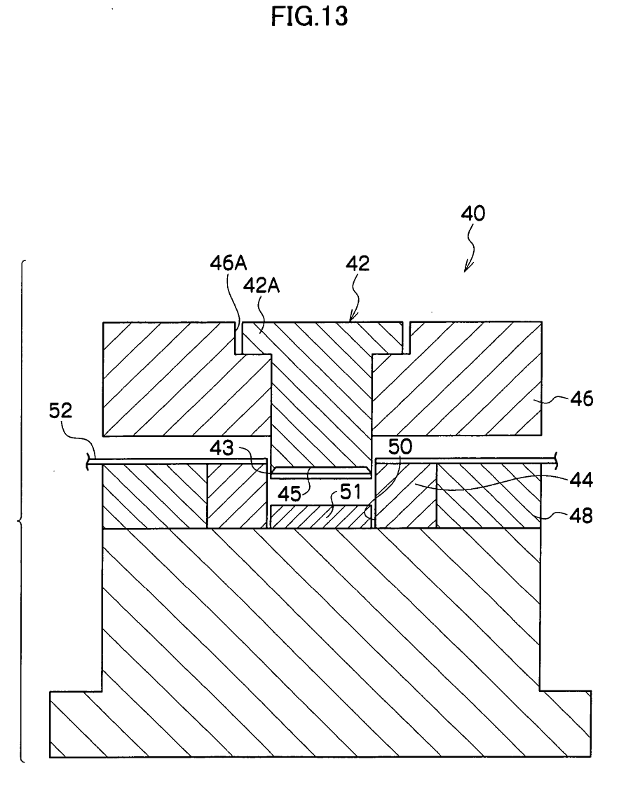

As shown in FIG. 13, the punching mold 40 has the punch holder 46 which holds the punch 42, and the die holder 48 which holds the die 44. The punch holder 46 and the die holder 48 are positioned by guide posts (not shown). The punch holder 46 is movable in the vertical direction with respect to the die holder 48.

The flange portion 42A is provided at the punch 42. The flange portion 42A is fixed by unillustrated bolts to the step portion 46A of the punch holder 46. In this way, as the punch holder 46 moves, the punch 42 moves in vertical directions with respect to the die 44. Note that FIGS. 9A and 9B are used in common to illustrate the present embodiment as well, and therefore, will be referred to in the explanation of the present embodiment.

As shown in FIGS. 9A and 13, the through-hole 50, with which the punch 42 can fit together, is formed in the die 44. In this way, when the punch 42 is lowered, the punch 42 fits together with the through-hole 50 of the die 44. Further, the punch restraining plate 51 is provided in the through-hole 50, and when the punch 42 is lowered, the punch 42 is supported by the punch restraining plate 51. Note that the flange portion 42A of the punch 42 is illustrated only in FIG. 13.

As shown in FIG. 9B, the workpiece 52 (sheet-like PET) is placed on the surface of the die 44 which surface faces the punch 42. Then, when the punch 42 is lowered and fits together with the through-hole 50 formed in the die 44, shearing force acts along the outer configuration of the punching surface of the punch 42, and the workpiece 52 is punched.

The punching surface of the punch 42 is the same configuration as that of the leader tape 30 which will be described later. Namely, the projecting portions 58, which have configurations corresponding to the jutting portions 34 (see FIG. 34) of the leader tape 30, are formed at one longitudinal direction end portion of the punching surface. The hole portion 56, with which the punch 53 for forming the hole 32 of the leader tape 30 can fit together, is provided in the one end portion of the punch 42. Due to the workpiece 52 being punched by the die 44 and the punch 42 having this configuration, the leader tape 30 of the configuration shown in FIG. 9B is formed.

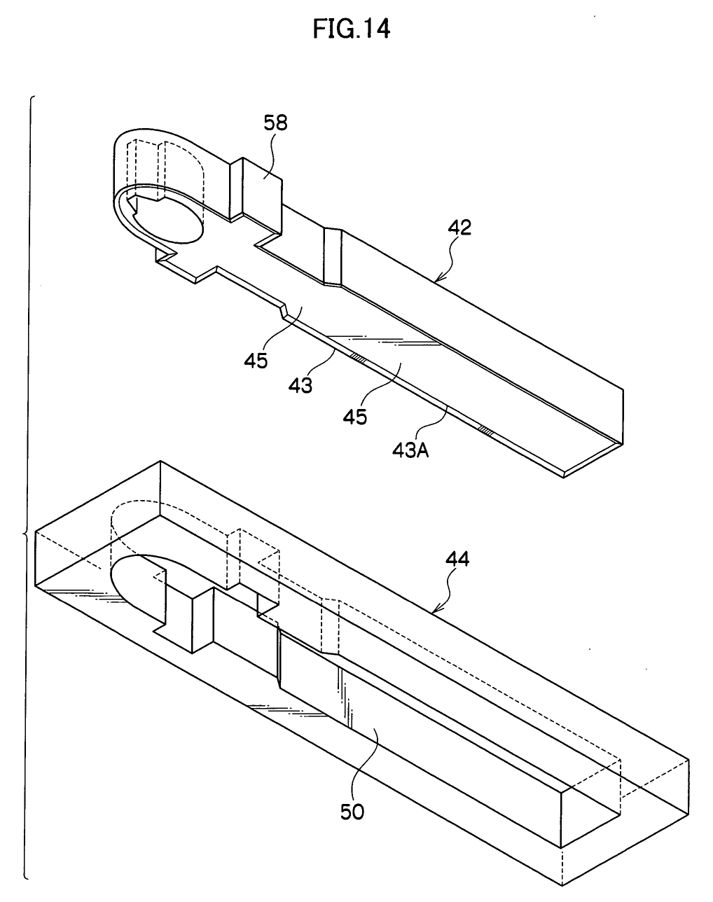

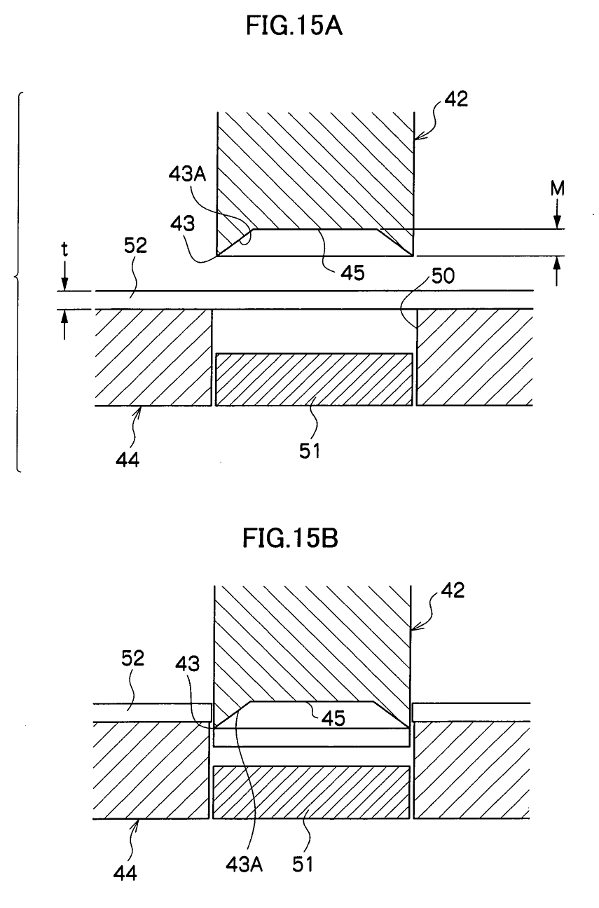

A view looking at the punch 42 from the punching surface side thereof is shown in FIG. 14, and views looking at the punch 42 from the side surface side thereof are shown in FIGS. 15A and 15B.

The punching surface of the punch 42 has the same configuration as the leader tape 30. Namely, the projecting portions 58, which have shapes corresponding to the jutting portions 34 of the leader tape 30, are formed at one longitudinal direction end portion of the punching surface.

The hole portion 56, with which the punch 53 for forming the hole 32 of the leader tape 30 can fit together, is provided in the one end portion of the punch 42. Due to the workpiece 52 being punched by the die 44 and the punch 42 having this configuration, the leader tape 30 having a configuration such as that shown in FIG. 9B is formed.

As shown in FIGS. 14, 15A, and 15B, a concave portion 45, which is similar to the outer shape of the punch 42, is formed at the punching surface of the punch 42. The concave portion 45 is formed by grinding. A taper is formed toward the concave portion 45 over all of the corner portion 43 except for the portion corresponding to the hole portion 56. The corner portion 43 is thereby formed to be an acute angle. Further, as shown in FIG. 15A, a depth M of the concave portion 45 (the distance from the distal end of the corner portion 43 to the floor surface of the concave portion 45) is formed to be greater than a thickness t of the workpiece 52 (i.e., such that t<M).

In this way, as shown in FIG. 15B, when the punch 42 is lowered, the corner portion 43, which is formed at an acute angle, abuts the workpiece 52. Then, the corner portion 43 fits together with the through-hole 50 of the die 44, and the workpiece 52 is punched along the outer shape of the punch 42.

Note that the present invention is structured such that the concave portion 45 is formed by grinding, but the method of machining the concave portion 45 is not limited to grinding. For example, in cases in which the surface area of the punching surface of the punch is small and it is difficult to form the concave portion 45 in the punching surface by grinding such that the corner portion is an acute angle, the concave portion can be formed by carrying out electric discharge machining on the punching surface by using an electrode at whose distal end portion is formed a configuration which is the reverse of the concave portion.

Operation of the embodiment of the present invention will be described next.

When forming a product having a long, thin configuration such as the leader tape 30 which is provided at the recording tape cartridge 10, if the workpiece is punched all at once by the punch 42 which is long and thin, the workpiece 52 receives rectilinear shearing force from the punch 42 and is distorted, and is pressed-into the through-hole 50 and punched.

Thus, by forming the corner portion 43 of the punching surface of the punch 42 at an acute angle, the shearing force which the workpiece 52 receives from the punch 42 concentrates linearly. In this way, there is little distortion of the workpiece 52, and the workpiece 52 is not pushed-into the through-hole 50, and shear droop does not arise. Namely, because there is no fear that the peripheral portions of the workpiece 52 which do not become the product will enter into the through-hole 50 of the die 44, burred edges do not remain at the end surfaces of the leader tape 30 which is punched-out and formed, and the end surfaces are not crushed. Accordingly, the end surfaces of the leader tape 30 can be formed with high precision.

By forming the concave portion 45 in the punching surface of the punch 42, the corner portion 43 can be formed as an acute angle by grinding in which the machining method is easy. It is thereby possible to keep the manufacturing cost of the punch 42 low.

By making the depth of the concave portion 45 be one to two times the thickness of the workpiece, when the corner portion 43 becomes worn, it suffices to merely grind a taper surface 43A of the corner portion 43 and not grind the concave portion 45.

Further, by forming the through-hole 50 of the die 44 to be rectilinear along the direction in which the punch 42 is fitted therein, a side surface portion 43B (a portion abutting the through-hole) of the corner portion 43 of the punch 42 which has entered in the through-hole 50 is supported at the through-hole 50 over the entire region thereof. In this way, when the punch 42 is fitted together with the through-hole 50, the load which the corner portion 43 receives from the through-hole 50 is reduced, and therefore, the durability of the corner portion 43 improves.

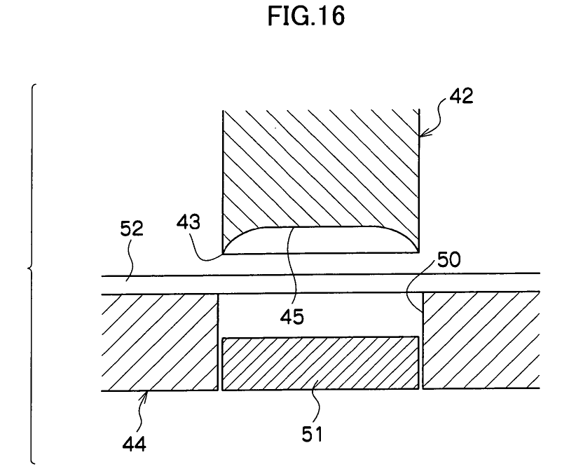

Note that the present embodiment is structured such that a taper is provided between the corner portion 43 and the concave portion 45, and the corner portion 43 is made to be an acute angle. However, as shown in FIG. 16, the region between the corner portion 43 and the concave portion 45 may be formed in a circular-arc shape, and the corner portion 43 may be formed at an acute angle. By forming the region between the corner portion 43 and the concave portion in a circular-arc shape in this way, the angle of the corner portion 43 is smaller than in a case in which a taper is formed between the corner portion 43 and the concave portion 45. Therefore, it is possible to form a leader tape 30 which has even more precise end surfaces.

### Fourth Embodiment

The punching mold 40 relating to the present embodiment will be described. Here, as shown in FIG. 1, explanation will be given by using as an example the punching mold 40 which forms the leader tape 30 which is provided at the magnetic tape cartridge 10 (see FIG. 34) for example. Note that FIG. 1 is used in common to illustrate the present embodiment as well, and therefore, will be referred to in the explanation of the present embodiment.

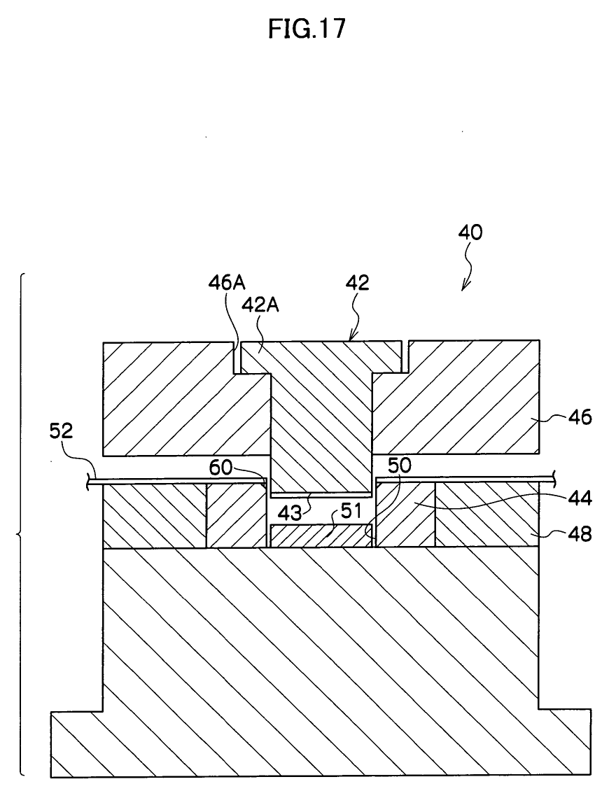

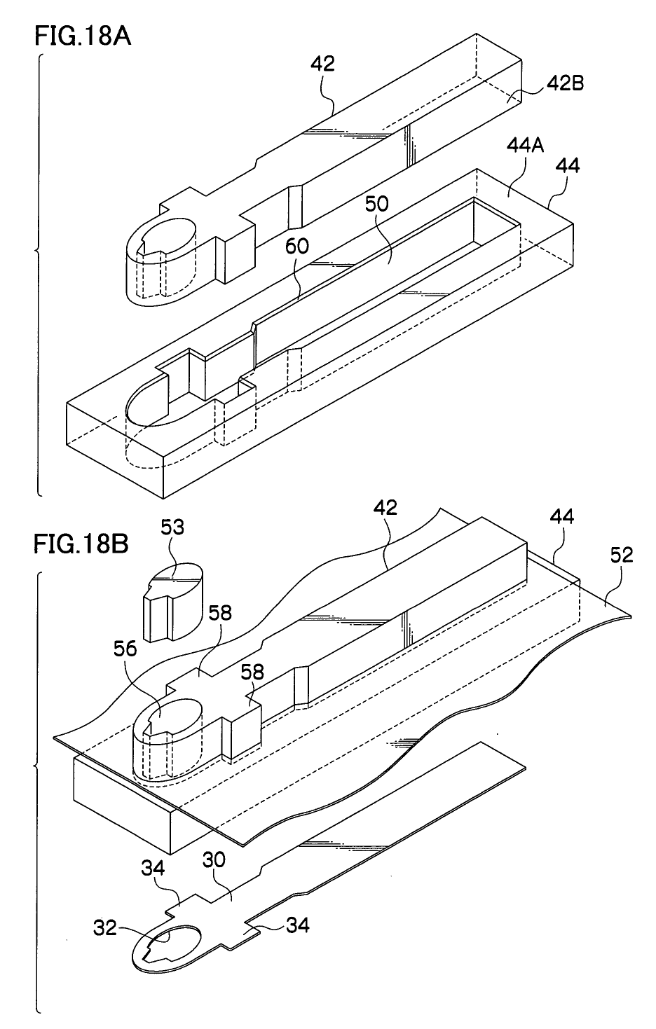

As shown in FIGS. 17 and 18A, the through-hole 50, with which the punch 42 can fit together, is formed in the die 44. In this way, when the punch 42 is lowered, the punch 42 fits together with the through-hole 50 of the die 44. Further, the punch restraining plate 51 is provided in the through-hole 50, and when the punch 42 is lowered, the punch 42 is supported by the punch restraining plate 51. Note that the flange portion 42A of the punch 42 is illustrated only in FIG. 17.

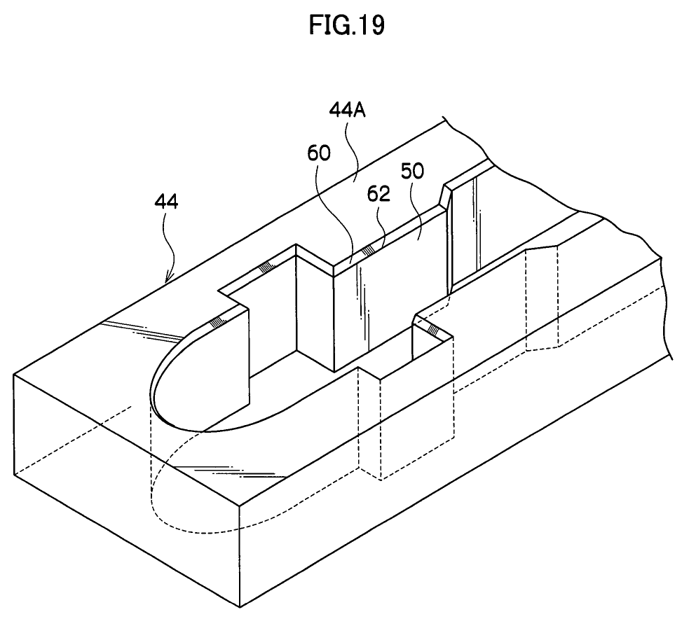

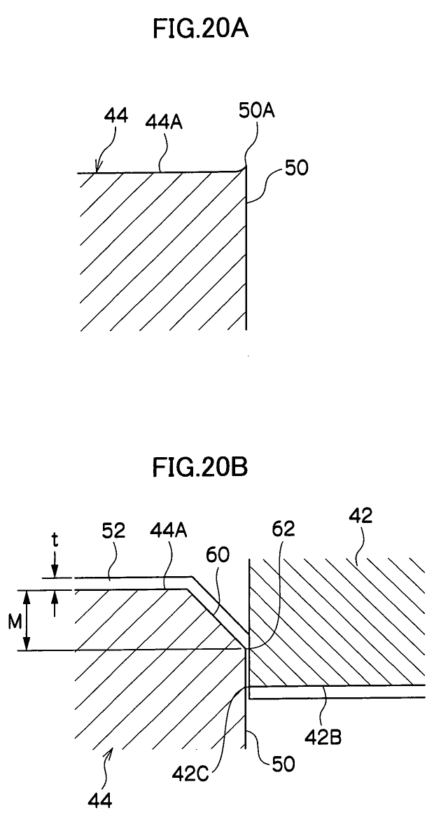

As shown in FIGS. 19, 20A and 20B, a peripheral edge portion 50A of the through-hole 50 of the die 44 is chamfered, and a taper surface 60 is formed. A corner portion 62 is formed by the through-hole 50 and the taper surface 60. As shown in FIG. 20B, the workpiece 52 is nipped-in by the corner portion 62 and a corner portion 42C of the punching surface 42B of the punch 42, and is punched.

By providing the taper surface 60 at the peripheral edge portion 50A of the through-hole 50 in this way, at the time of forming the through-hole 50 in the die 44, even if burrs are formed at the peripheral edge portion 50A of the through-hole 50 of the die 44 as shown in FIG. 20A, the burrs are shaved-off as shown in FIG. 20B. Accordingly, the feeding of the workpiece 52 on the placement surface 44A of the die 44 is not impeded. Further, there is no fear of scratching the workpiece 52.

The taper surface 60 is formed such that a distance M from the placement surface 44A to the corner portion 62 is greater than a thickness t of the workpiece (i.e., such that t≦M). In this way, burrs which are formed at the peripheral edge portion 50A of the through-hole 50 at the time of forming the through-hole 50 can be reliably removed.

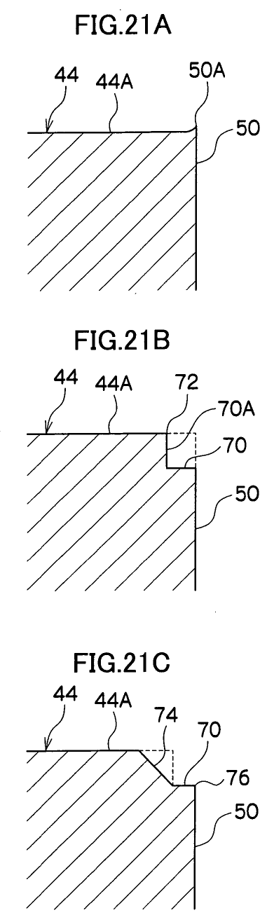

Note that the present embodiment is structured such that the peripheral edge portion 50A of the through-hole 50 is chamfered and the taper surface 60 is provided, as shown in FIGS. 19, 20A and 20B. However, as shown in FIGS. 21A through 21C, a step surface 70 which is parallel to the placement surface 44A may be formed at the peripheral edge portion 50A, and a taper surface 74 may be formed by chamfering a corner portion 72 which is formed by the placement surface 44A and an upright surface 70A of the step surface 70.

In this way, a substantially right-angled corner portion 76, which is formed by the through-hole 50 and the step surface 70 which is parallel to the placement surface 44A, corresponds to the portion which fits-together with the corner portion 42C of the punching surface 42B of the punch 42 (see FIG. 20B), i.e., the cutting blade of the die 44. Accordingly, shearing force works effectively on the workpiece 52 which is nipped between the corner portion 76 of the die 44 and the corner portion 42C of the punching surface 42B of the punch 42. Therefore, the punching of the workpiece 52 is carried out smoothly, and the end surfaces of the leader tape 30 (see FIG. 18B) can be formed with high precision.

Further, when the corner portion 76 becomes worn, it suffices to grind the step surface 70. In this way, because there is no need to grind the placement surface 44A, the position of the placement surface 44A does not change, and there is no worry that the feeding position of the workpiece 52 will become offset. Moreover, because the surface area which is ground is smaller than in a case in which the placement surface 44A is ground, the grinding time is shortened.

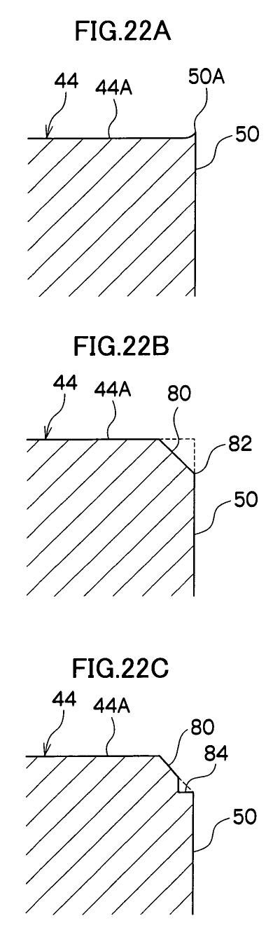

Other than the above-described form, as shown in FIG. 22B, the peripheral edge portion 50A of the through-hole 50 may be chamfered so as to form a taper surface 80, and, as shown in FIG. 22C, a step surface 84, which is parallel to the placement surface 44A, may be formed at a corner portion 82 which is formed by the taper surface 80 and the through-hole 50.

Moreover, the present embodiment is structured such that the peripheral edge portion 50A of the through-hole 50 is chamfered and the taper surface 60 is provided. However, it is possible to prevent feeding of the workpiece 52 from being impeded, by providing a taper surface at least at the corner portions which are substantially orthogonal to the feeding direction of the workpiece 52.

### Fifth Embodiment

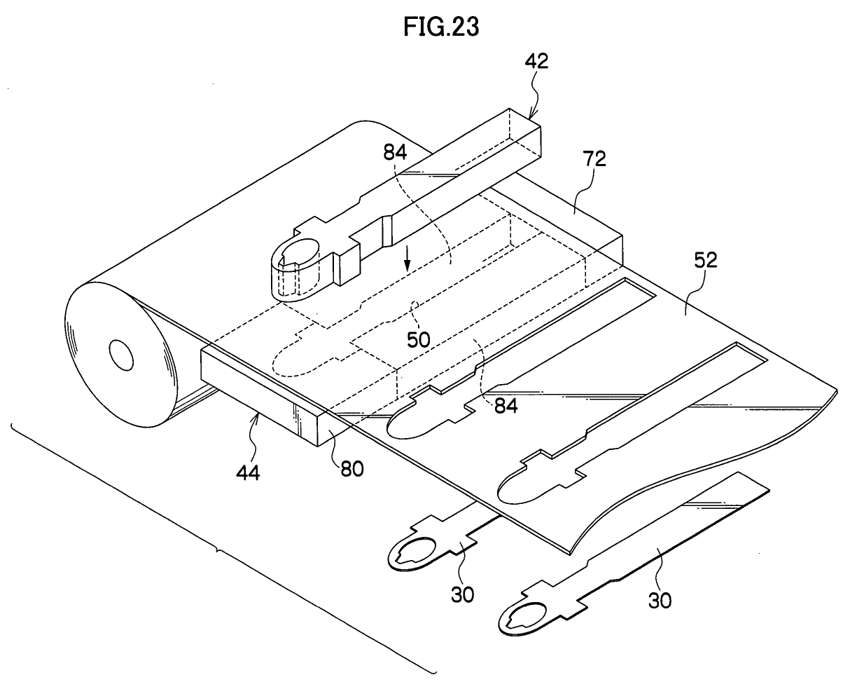

The punching mold 40 relating to the present embodiment will be described. Here, as shown in FIG. 23, explanation will be given by using as an example the punching mold 40 which forms the leader tape 30 which is provided at the magnetic tape cartridge 10 (see FIG. 34) for example.

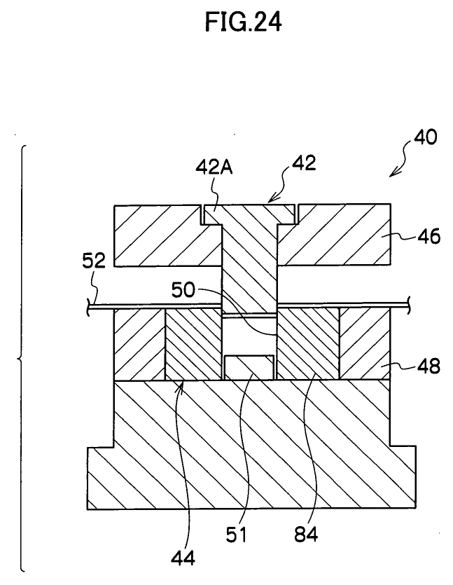

As shown in FIG. 24, the punching mold 40 has the punch holder 46 which holds the punch 42, and the die holder 48 which holds the die 44. The punch holder 46 and the die holder 48 are positioned by guide posts (not shown). The punch holder 46 is movable in the vertical direction with respect to the die holder 48.

The flange portion 42A is provided at the punch 42. The flange portion 42A is fixed by unillustrated bolts to the step portion 46A of the punch holder 46. In this way, as the punch holder 46 moves, the punch 42 moves in vertical directions with respect to the die 44.

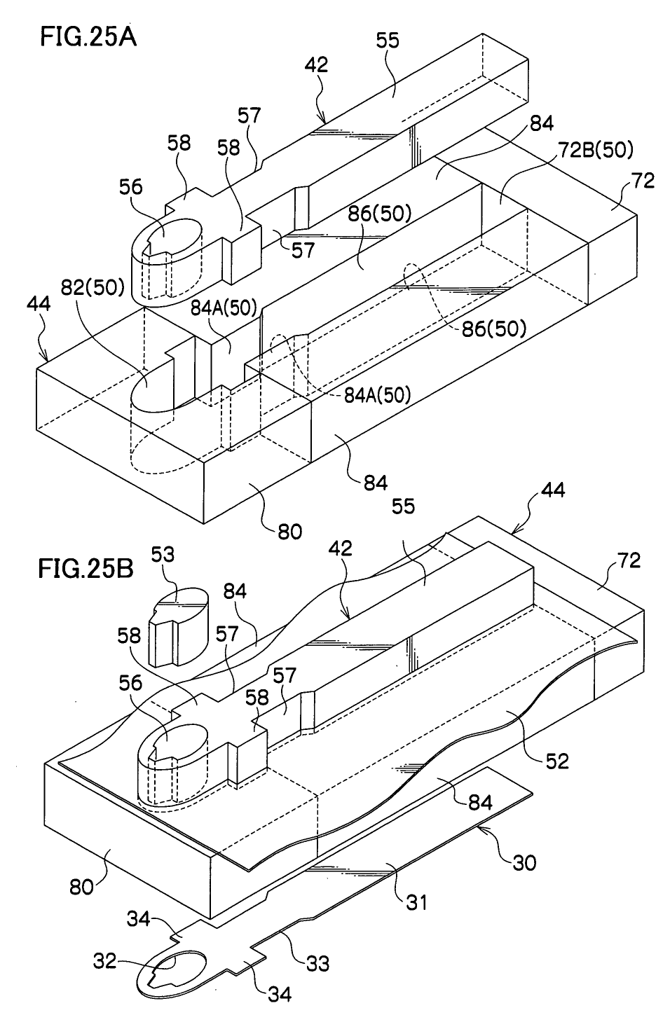

As shown in FIGS. 24 and 25A, the through-hole 50 (structured by a through-hole 82, a side wall 80A, step portions 86, and a side wall 72B which will be described later), with which the punch 42 can fit together, is formed in the die 44 (details of which will be described later). In this way, when the punch 42 is lowered, the punch 42 fits together with the through-hole 50 of the die 44. Further, a punch restraining plate 51 is provided in the through-hole 50, and when the punch 42 is lowered, the punch 42 is supported by the punch restraining plate 51. Note that, for convenience, the flange portion 42A of the punch 42 and the punch restraining plate 51 are illustrated only in FIG. 24.

As shown in FIG. 25B, the workpiece 52 (sheet-like PET) is placed on the surface of the die 44 which surface faces the punch 42. Then, when the punch 42 is lowered and fits-together with the through-hole 50 formed in the die 44, shearing force acts along the outer configuration of the punching surface 43 of the punch 42, and the workpiece 52 is punched.

The punching surface 43 of the punch 42 is the same configuration as that of the leader tape 30. Namely, the punching surface 43 has a straight portion 55, which corresponds to the elongated portion 31 of the leader tape 30, and the projecting portions 58, which have configurations corresponding to the jutting portions 34 of the leader tape 30, are formed at an end portion of the straight portion 55. Further, concave portions 57, which correspond to the concave portions 33 of the leader tape 30, are formed in the straight portion 55 in vicinities of the projecting portions 58.

The hole portion 56, with which the punch 53 for forming the hole 32 of the leader tape 30 can fit together, is provided in the one end portion of the punch 42. Due to the workpiece 52 being punched by the die 44 and the punch 42 having this configuration, the leader tape 30 of the illustrated configuration is formed.

Here, the structure of the die 44 will be explained.

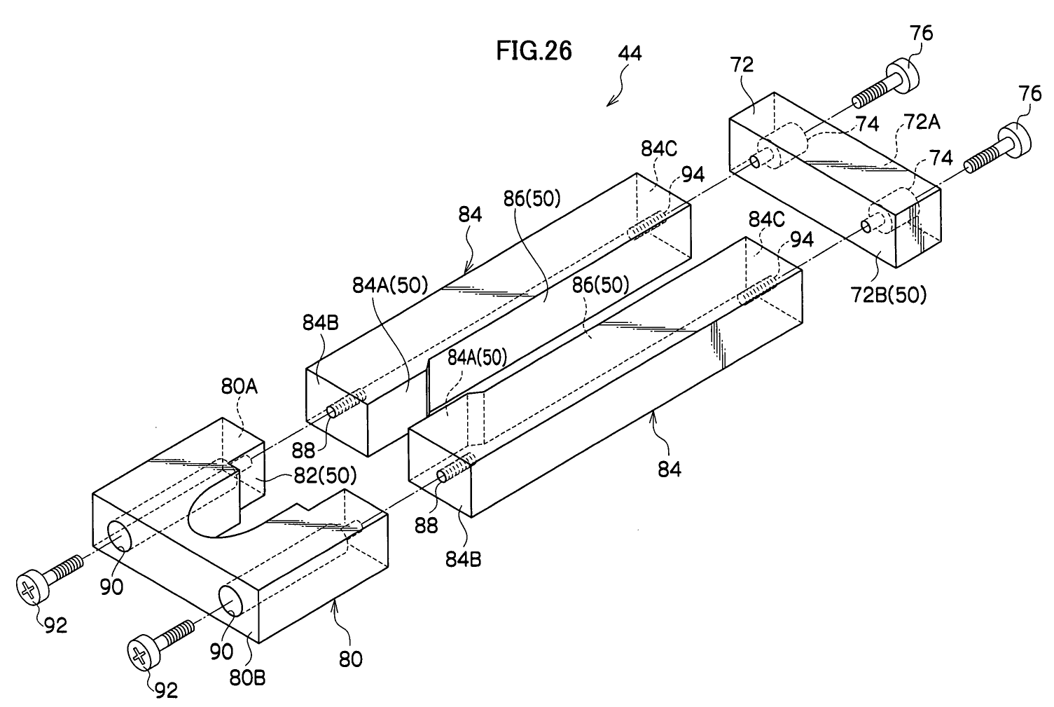

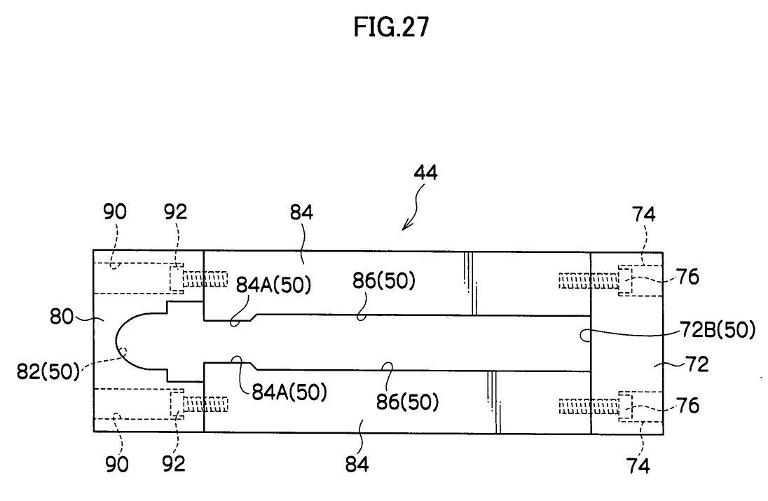

As shown in FIGS. 25A, 25B, 26, and 27, the die 44 has a first block 80. The through-hole 82, with which the projecting portions 58 of the punch 42 can fit together, is formed in the first block 80. The through-hole 82 is formed so as to be open at the one side wall 80A of the first block 80, and is formed in substantially a U-shape as seen in plan view.

Two second blocks 84 are provided at the near side and the far side in the drawings, at the one side wall 80A of the first block 80. The substantially rectangular-solid-shaped second blocks 84 are elongated and have lengths corresponding to the straight portion 55 of the punch 42, and are disposed parallel to one another with a predetermined interval therebetween. The step surfaces 86 are formed at side walls 84A which run along the longitudinal direction of the second blocks 84. The two second blocks 84 are disposed such that the side walls 84A, at which the step surfaces 86 are formed, face one another. In this way, the concave portions 57 of the punch 42 fit in the gap formed by the side walls 84A of the two second blocks 84, and the straight portion 55 of the punch 42 fits in the gap formed by the step surfaces 86 of the two second blocks 84.

Taps 88 are formed in one side walls 84B in the longitudinal direction of the second blocks 84. Screws 92, which are inserted through screw holes 90 formed in another side wall 80B of the first block 80, are screwed-into the taps 88. The second blocks 84 are thereby fixed to the side wall 80A of the first block 80.

A third block 72, which is shaped as a rectangular solid, is provided at other end walls 84C in the longitudinal direction of the second blocks 84. The opening portion of the through-hole 50 (structured by the through-hole 82, the side walls 84A, and the step portions 86), which is formed by the two second blocks 84 which are fixed to the first block 80, is closed by the one side wall 72B of the third block 72.

Screw holes 74 are formed in another side wall 72A of the third block 72. Screws 76, which are inserted through the screw holes 74, are screwed-into taps 94 which are formed in the other side walls 84C of the second blocks 84. The third block 72 is thereby fixed to the second blocks 84.

In this way, the die 44 is formed by the first block 80, the second blocks 84, and the third block 72. The through-hole 50, with which the punch 42 can fit-together, is formed by the through-hole 82 of the first block 80, the gaps formed by the side walls 84A and the step portions 86 of the two second blocks 84, and the side wall 72B of the third block 72.

Operation of the present embodiment will be described next.

The punch 42 is fitted together with the through-hole 50 which is formed by the first block 80 which forms the elongated portion 31 of the leader tape 30, the second blocks 84 which form the jutting portions 34 of the leader tape 30, and the third block 72, and the leader tape 30 is formed.

By dividing the die 44 into plural blocks in this way, as compared with a case in which the die 44 is structured as one mold, the time for manufacturing the punching mold 40 can be shortened, and a punching mold 40 which is highly precise can be manufactured. It is thereby possible to obtain a leader tape 30 whose manufacturing costs are kept low and whose end surfaces are highly precise.

Even in cases in which the first block 80, the second blocks 84, and the third block 72 become worn, it suffices to newly manufacture only the block corresponding to the worn portion or to grind the worn portion, and the maintainability is improved.

Further, because the rectilinear portions of the second blocks 84, which form the elongated portion 31 of the leader tape 30, are not divided, the separation line between the first block 80 and the second blocks 84 does not arise at the end surfaces of the elongated portion 31 of the leader tape 30. In this way, there is no concern that burrs or the like will arise at the end surfaces of the elongated portion 31 of the leader tape 30.

The second blocks, which form the longitudinal direction end surfaces of the leader tape 30, can be formed independently by grinding. Therefore, the end surfaces of the leader tape 30 can be formed with high precision over the entire longitudinal direction region.

As compared with a case in which the elongated portion 31 of the leader tape 30 is formed by an integral block without carrying out forming by separating the mold into the second blocks 84 and the third block 72, adjustment of the transverse direction dimension of the through-hole 50 is easy to carry out. Therefore, the gap between the through-hole 50 and the punch 42 which fits-together with the through-hole 50 can be made to be uniform over the entire longitudinal direction region.

Note that, in the present embodiment, explanation is given by using as an example the punching mold 40 which punches the leader tape 30 which is provided at the recording tape cartridge 10. However, the present invention is not particularly limited to the punching mold 40 of the leader tape 30. The present invention is effective in a punching mold which forms a product having an elongated shape and, at a portion thereof, a shape which is different than that of the elongated portion.

### Sixth Embodiment

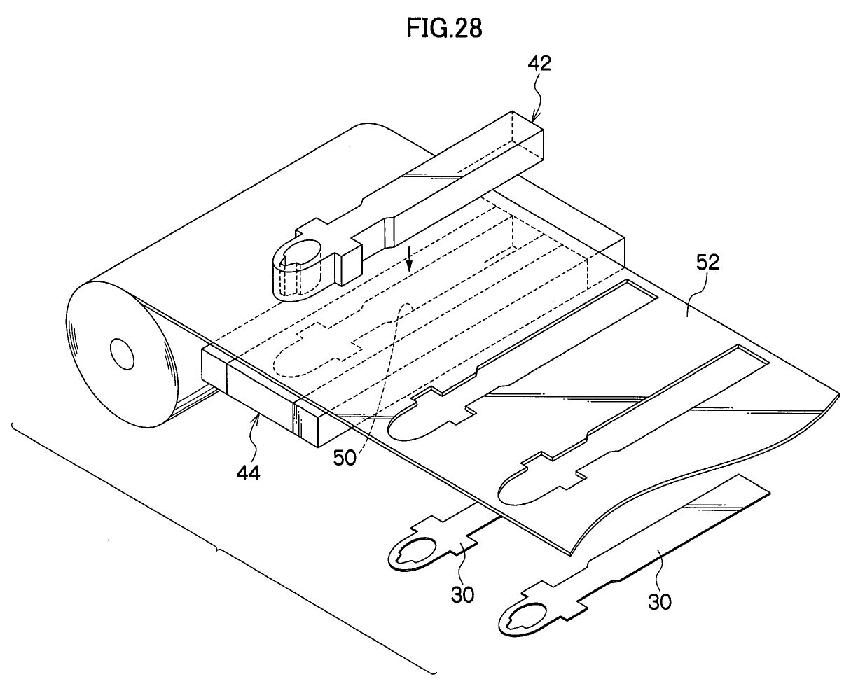

The punching mold 40 relating to the present embodiment will be described. Here, as shown in FIG. 28, explanation will be given by using as an example the punching mold 40 which forms the leader tape 30 which is provided at the magnetic tape cartridge 10 (see FIG. 34) for example.

As shown in FIG. 2, the punching mold 40 has the punch holder 46 which holds the punch 42, and the die holder 48 which holds the die 44. The punch holder 46 and the die holder 48 are positioned by guide posts (not shown). The punch holder 46 is movable in the vertical direction with respect to the die holder 48.

The flange portion 42A is provided at the punch 42. The flange portion 42A is fixed by unillustrated bolts to the step portion 46A of the punch holder 46. In this way, as the punch holder 46 moves, the punch 42 moves in vertical directions with respect to the die 44.

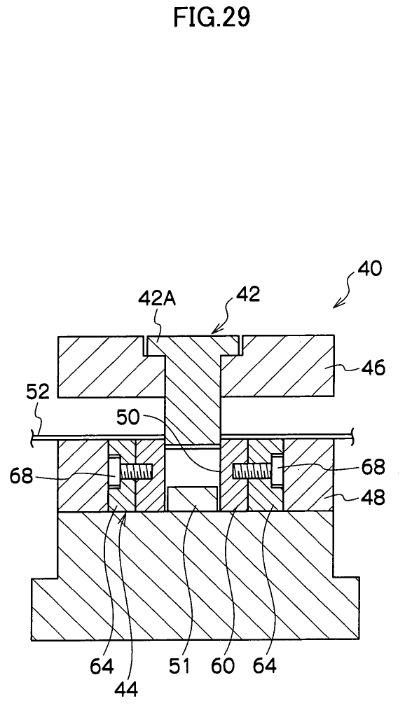

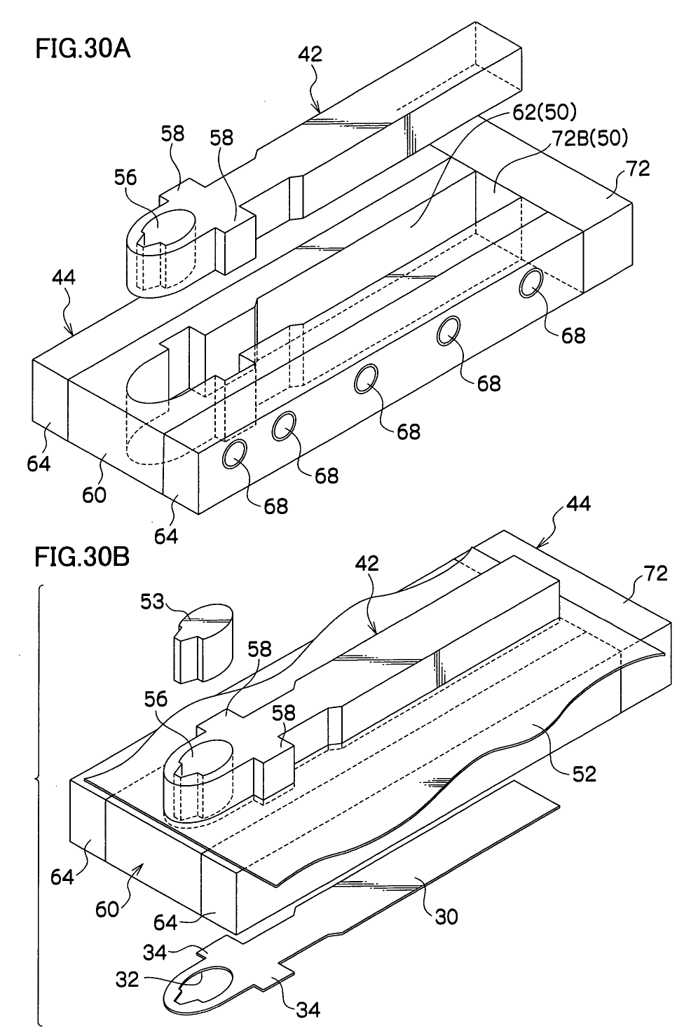

As shown in FIGS. 29 and 30A, the through-hole 50, with which the punch 42 can fit together, is provided in the die 44 (details of which will be described later). In this way, when the punch 42 is lowered, the punch 42 fits together with the through-hole 50 of the die 44. Further, the punch restraining plate 51 is provided in the through-hole 50, and when the punch 42 is lowered, the punch 42 is supported by the punch restraining plate 51. Note that, for convenience, the flange portion 42A of the punch 42 and the punch restraining plate 51 are illustrated only in FIG. 29.

As shown in FIG. 30B, the workpiece 52 (sheet-like PET) is placed on the surface of the die 44 which surface faces the punch 42. Then, when the punch 42 is lowered and fits-together with the through-hole 50 formed in the die 44, shearing force acts along the outer configuration of the punching surface 43 of the punch 42, and the workpiece 52 is punched.

The punching surface 43 of the punch 42 is the same configuration as that of the leader tape 30 which will be described later. Namely, the projecting portions 58, which have configurations corresponding to the jutting portions 34 of the leader tape 30, are formed at one longitudinal direction end portion of the punching surface 43. The hole portion 56, with which the punch 53 for forming the hole 32 of the leader tape 30 can fit together, is provided in the one end portion of the punch 42. Due to the workpiece 52 being punched by the die 44 and the punch 42 having this configuration, the leader tape 30 of the illustrated configuration is formed.

Here, the structure of the die 44 will be explained.

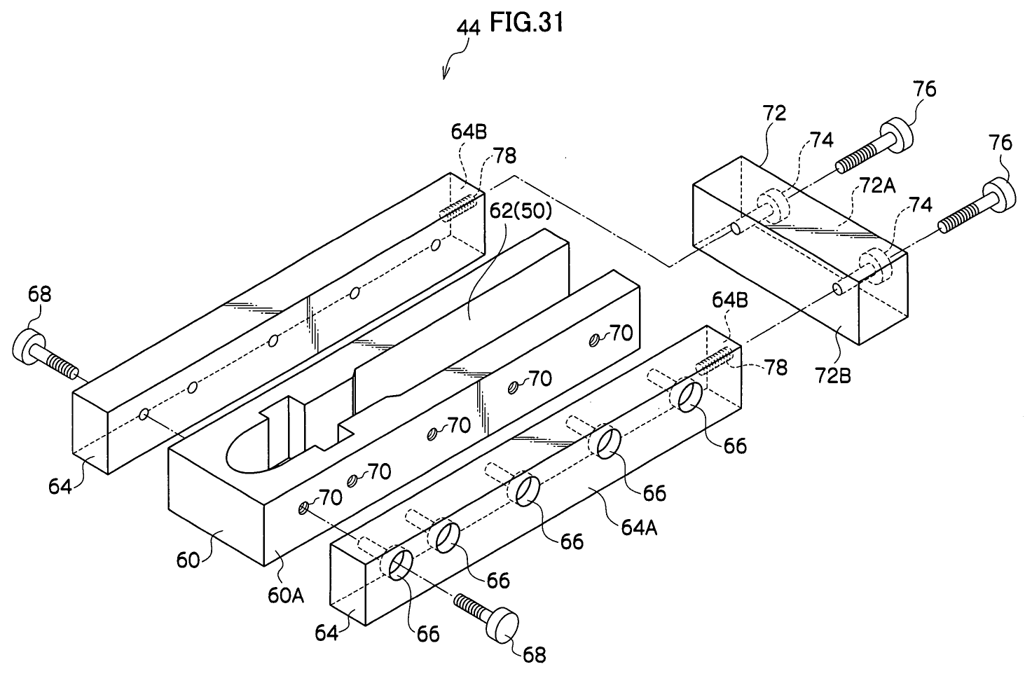

As shown in FIGS. 30A, 30B, 31, and 32, the die 44 has an elongated block 60. A concave portion 62 serving as the through-hole 50 is formed so as to pass through the block 60. The concave portion 62 has a configuration which runs along the outer shape of the punch 42, and the punch 42 can fit-together therewith. The portion of the block 60 corresponding to the other end portion of the punch 42 (the end portion at the side opposite the side where the projecting portions 58 are formed) is open, such that the block 60 is formed in substantially a U shape as seen in plan view.

Pressing members 64 are provided along the longitudinal direction at both transverse direction side walls 60A of the block 60. Screw holes 66 are formed in side walls 64A of the pressing members 64. Screws 68, which pass through the screw holes 66, are screwed-together with taps 70 formed in the side walls 60A of the block 60. The pressing members 64 are thereby fixed to the side walls 60A of the block 60.

A restraining member 72 is provided at one longitudinal direction end portion (the open side end portion) of the block 60. Screw holes 74 are formed in one side wall 72A of the restraining member 72, at two places along the longitudinal direction. Screws 76, which pass through the screw holes 74, are screwed together with taps 78 formed in longitudinal direction side walls 64B of the pressing members 64. The restraining member 72 is thereby fixed to the pressing members 64.

When the pressing members 64 are fixed at the restraining member 72, the opening of the block 60 is closed by another side wall 72B of the restraining member 72. The through-hole 50 is thereby formed by the concave portion 62 formed in the block 60 and the side wall 72B of the restraining member 72. The punch 42 is fitted together with the through-hole 50.

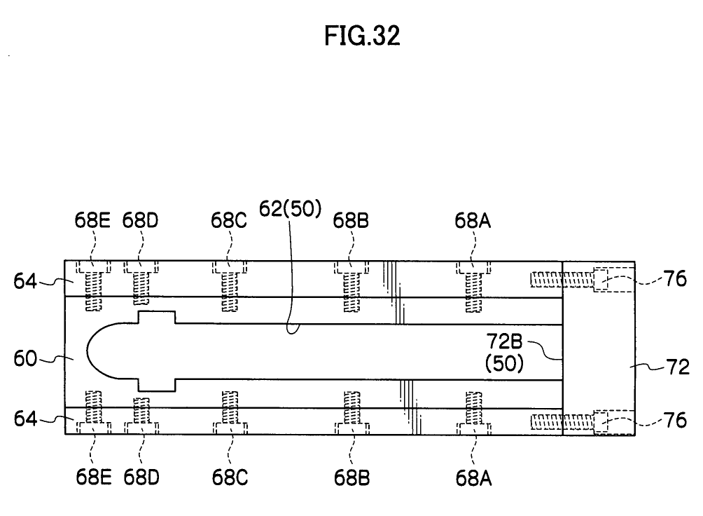

A view showing the state in which the punch 42 is fitted together with the through-hole 50, as seen from above, is shown in FIG. 32. The block 60 and the pressing members 64 are fixed by the five screws 68A, 68B, 68C, 68D, 68E along the longitudinal direction.

Note that the present embodiment is structured such that, in order to fix the pressing members 64 to the block 60, they are screwed-together at five places along the longitudinal direction. However, the number of places of screwing can be determined in accordance with the length of the leader tape which is to be punched-out.

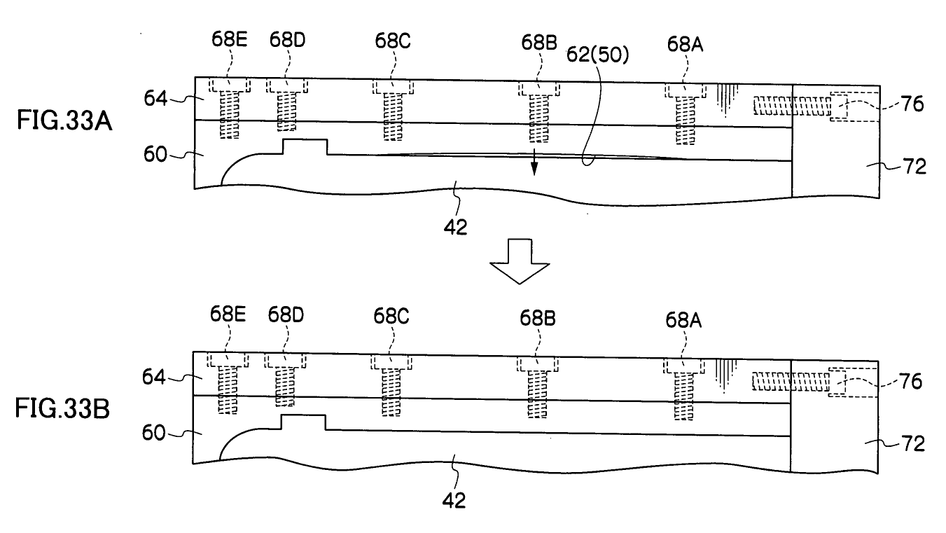

As shown in FIG. 33A, the punch 42 is fitted together with the through-hole 50. At this time, if the gap between the through-hole 50 and the punch 42 is greater than a predetermined value (10 μm in the present embodiment), the screw 68 which is fixing that portion is tightened.

For example, in the present embodiment, the gap between the through-hole 50 and the punch 42 becomes greatest at substantially the central portion in the longitudinal direction. Thus, the screw 68B which is fixing a vicinity of that central portion is tightened, such that substantially central portion of the block 60 is pressed by the substantially central portion of the pressing member 64. In this way, as shown in FIG. 33B, the substantially central portion of the block 60 (in a vicinity of where the screw 68B is provided) flexes toward the inner side of the through-hole 50. The gap between the through-hole 50 and the punch 42 is thereby made smaller.

By tightening the screws 68 in accordance with the size of the gap between the through-hole 50 and the punch 42 in this way, the gap between the through-hole 50 and the punch 42 can be made to be uniform along the entire longitudinal direction region.

Operation of the present embodiment will be described next.

When punching the leader tape 30 out from the workpiece 52, the configurations of the punch 42 and the through-hole 50 must be made to be elongated in correspondence with the outer shape of the leader tape 30. However, it is difficult to form an elongated member to have a uniform dimension in the longitudinal direction. Namely, there are cases in which the dimensions of the through-hole 50 and the punch 42 are not formed uniformly along the entire longitudinal direction region. In this state, when the punch 42 is fitted into the through-hole 50, a gap arises between the through-hole 50 and the punch 42.

Thus, the block 60 is pressed by the pressing members 64 which are provided at the outer sides of the block 60, and is flexed toward the inner side of the through-hole 50 (the direction in which the through-hole 50 becomes smaller). In this way, a portion where the gap between the through-hole 50 and the punch 42 is large is pressed from the outer side of the block 60. The gap between the through-hole 50 and the punch 42 can thereby be made to be uniform over the entire longitudinal direction region of the through-hole 50. In this way, even in cases of punching an elongated product such as the leader tape 30, burrs do not form at the end surfaces of the leader tape 30. Accordingly, the leader tape 30, whose end surfaces are formed highly precisely, can be obtained.

By structuring the die 44 by the block 60, in which the through-hole 50 is formed, and the pressing members 64, which press the block 60, in cases in which the through-hole 50 (the concave portion 62) becomes worn, it suffices to replace only the block 60. In this way, there is no need to re-manufacture the die 44 due to wearing, and the maintainability also improves. This therefore relates to a reduction in overall costs.

In a case in which the punch 42 becomes worn, if the block 60 is pressed by the pressing members 64 in accordance with the degree of wear, the gap between the through-hole 50 and the punch 42 which arises due to wear can be adjusted to a predetermined interval.

Further, the end surfaces of the leader tape 30 along the longitudinal direction are formed by the block 60, in which the through-hole 50 opens at a side wall such that the block 60 is formed in a substantial U shape. The end surface, at the side opposite the side where the jutting portions 34 of the leader tape 30 are provided, is formed by the restraining member 72. In this way, the machining of the through-hole 50 is easy as compared with a case in which the block 60 and the restraining member 72 are formed integrally. The manufacturing cost of the die 44 can thereby be suppressed.

Note that, in the present embodiment, explanation is given by using as an example the punching mold 40 which punches the leader tape 30 which is provided at the recording tape cartridge 10. However, the present invention is not particularly limited to the punching mold 40 of the leader tape 30. The present invention is effective in a punching mold which forms an elongated product such as the leader tape 30.

While the present invention has been illustrated and described with respect to specific embodiments thereof, it is to be understood that the present invention is by no means limited thereto and encompasses all changes and modifications which will become possible without departing the scope of the appended claims.

What is claimed is:

1. A punching mold having a die in which a through-hole is formed, and a punch which fits-together with the through-hole and which punches a workpiece which is placed on the die,
wherein a step surface is formed at a punching surface of the punch which punching surface contacts the workpiece, and a block, which abuts the step surface and impedes punching of a step surface portion, is fitted together with the through-hole.

2. The punching mold of claim 1, wherein a punching size is changed by changing a size of the step surface.

3. A punching mold having a die in which a through-hole is formed, and a punch which fits-together with the through-hole and which punches a workpiece which is placed on the die,
wherein, when the punch punches the workpiece, punching times at which the workpiece is punched are made to be different at one longitudinal direction end portion of the punch from at another longitudinal direction end portion of the punch.

4. The punching mold of claim 3, wherein the punching times are made to be different by inclining the punching surface of the punch, which punching surface punches the workpiece, from the one longitudinal direction end portion of the punch toward the other longitudinal direction end portion of the punch.

5. The punching mold of claim 3, wherein a step surface is formed at the punching surface of the punch which punching surface contacts the workpiece, and the step surface is inclined from one end portion toward another end portion.

6. The punching mold of claim 5, wherein the step surface is formed at the punching surface by a step which is greater than or equal to a thickness of the workpiece.

7. The punching mold of claim 5, wherein a border between the step surface and the punching surface is provided at a portion other than a straight portion of a product which is formed by punching the workpiece.

8. The punching mold of claim 6, wherein a border between the step surface and the punching surface is provided at a portion other than a straight portion of a product which is formed by punching the workpiece.

9. A punching mold having a die in which a through-hole is formed, and a punch which fits together with the through-hole and which punches a workpiece which is placed on the die,
wherein, at the punch, a corner portion of a punching surface which contacts and punches the workpiece, is formed at an acute angle.

10. The punching mold of claim 9, wherein the corner portion is formed at an acute angle by forming a concave portion in the punching surface at a region other than the corner portion.

11. The punching mold of claim 9, wherein a depth of the concave portion is greater than or equal to a thickness of the workpiece.

12. The punching mold of claim 10, wherein a depth of the concave portion is greater than or equal to a thickness of the workpiece.

13. The punching mold of claim 9, wherein the through-hole is rectilinear along a direction in which the punch fits together with the through-hole.

14. The punching mold of claim 10, wherein the through-hole is rectilinear along a direction in which the punch fits together with the through-hole.

15. The punching mold of claim 11, wherein the through-hole is rectilinear along a direction in which the punch fits together with the through-hole.

16. The punching mold of claim 12, wherein the through-hole is rectilinear along a direction in which the punch fits together with the through-hole.

17. A punching mold comprising:
a die in which a through-hole is formed at a placement surface on which a workpiece is placed; and
a punch which fits together with the through-hole, and which punches the workpiece which is placed on the placement surface,
wherein a corner portion of the through-hole, which is substantially orthogonal to a direction of feeding the workpiece, is chamfered.

18. The punching mold of claim 17, wherein a depth of the corner portion which is chamfered is greater than or equal to a thickness of the workpiece.

19. A punching mold comprising:
a die in which a through-hole is formed at a placement surface on which a workpiece is placed; and
a punch which fits together with the through-hole, and which punches the workpiece which is placed on the placement surface,
wherein a step surface, which is parallel to the placement surface, is provided at a corner portion at a peripheral edge of the through-hole, and a corner portion, which is formed by the placement surface and an upright surface of the step surface, is chamfered.

20. A leader tape punching mold which forms a leader tape, the punching mold having a die in which a through-hole is formed, and a punch which fits together with the through-hole and which punches a workpiece which is placed on the die, and the punching mold being structured so as to form a leader tape having an elongated portion, which is attached to an end portion of a recording tape and which is provided in an elongated form along a longitudinal direction of the recording tape, and jutting portions, which are provided at a distal end of the elongated portion and jut-out in a transverse direction of the recording tape,
wherein the die is structured by combining a first mold which forms the elongated portion, and a second mold which forms the jutting portions of the leader tape.

21. The leader tape punching mold of claim 20, wherein the first mold is structured by a first member which forms edge surfaces of the elongated portion which are parallel to a longitudinal direction, and a second member which forms an end surface of the elongated portion at an end opposite to the end where the jutting portions are formed.

22. A punching mold comprising:
a die structured by a block in which a through-hole is formed, and a pressing member which is provided at an outer side of the block and which presses the block; and
a punch which fits together with the through-hole and punches a workpiece which is placed on the die.

23. The punching mold of claim 22, wherein the block and the pressing member are connected by bolts, and the block is pressed by the pressing member by tightening the bolts.

24. The punching mold of claim 22, wherein the block is structured by a first member which forms an end surface in one direction of a product, and a second member which forms end surfaces other than the end surface in the one direction.

25. The punching mold of claim 23, wherein the block is structured by a first member which forms an end surface in one direction of a product, and a second member which forms end surfaces other than the end surface in the one direction.
